(19) United States
(12) Patent Application Publication
(10) Pub. No.: US 2003/0061279 A1
(43) Pub. Date: Mar. 27, 2003

(54) Application serving apparatus and method

(76) Inventors: Scot Llewellyn, Orem, UT (US); Paul Watt, Salt Lake City, UT (US); Joseph Ivie, American Fork, UT (US); Doug Schultz, Cedar Hills, UT (US); Shawn Stevens, Alpine, UT (US); Ryan Carlson, Riverton, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 10/145,377

(22) Filed: May 14, 2002

Related U.S. Application Data
(60) Provisional application No. 60/291,458, filed on May 15, 2001.
(60) Provisional application No. 60/304,041, filed on Jul. 8, 2001.

(51) Int. Cl. G06F 15/16

(52) U.S. Cl. 709/203; 709/211

(57) ABSTRACT

An apparatus and method enables remote access and control of applications. The processing of the application takes place in multiple locations. One typically being a server whereon the application is installed. Another is the workstation of a user. The workstation typically provides user interface processing and the server handles the execution of the application. The apparatus may provide efficient use of resources by reducing the amount of data that must be passed between the workstation and the server. The apparatus may include applications enabling multiple users to access and control the same instance of a running application. The apparatus may also allow a provider of a service to see a user's screen and control the computer of a user.

### RELATED APPLICATIONS

This application claims the benefit of U.S. provisional application Serial No. 60/291,458, filed May 15, 2001 and entitled APPLICATION SERVER APPARATUS AND METHOD. This application also claims the benefit of U.S. provisional application Serial No. 60/304,041, filed Jul. 8, 2001 and entitled SUBSCRIBER APPLICATION APPARATUS AND METHOD.

### BACKGROUND

1. The Field of the Invention

The invention relates generally to computer systems, and more specifically to methods and apparatus for providing an application server that enables a software application to execute on one computer (e.g. a server), while the software application is controlled and operated by one or more users at other computer(s) (e.g. workstation(s)). The invention also relates to applications enabling multiple users to access and control a single running application.

2. Background

The computer age has advanced from analog computers having hard-wired program instructions up through programmable digital computers, and now highly networked programmable digital computers sharing information and applications across the world. With the advent of the computer as a business tool, nearly every profession now requires access to a computer in order to properly complete the daily routine of a job. Applications (computer programs) have grown in size and number to address numerous needs in numerous industries. Those applications can collect information, store information, retrieve information, send and receive communications and information, create graphic or text files, and so forth.

As networking has become more pervasive in the computer arts, internetworks have become prominent. In general, an internetwork is a network that includes more than one network, independent from one another, connected by a router. The ultimate internetwork today is often referred to as the Internet. The Internet includes a confederation of virtually any computer in the world having access to an Internet Service Provider (ISP). ISPs manage the routing and serving functions required in order to transfer packets of information between a set of subscribers, and a backbone computer network that has access to “the Internet.”

Thus, the Internet has placed in the hands of every individual user of a computer, through an ISP the ability to access any other computer that has been connected to cooperate in the Internet.

Early computer services, referring to computer services delivered by servers over telecommunications networks such as the telephone system, relied on paid subscribers who dialed a specific phone number, to access a server by way of telephone communication lines. Although the hardware suite remains substantially the same, software architectures have changed. For example, the browser is an application on a computer for accessing an ISP and the Internet beyond. A browser is an application executing on the processor of a computer in order to manage the uploading and downloading of menus, selections, content, and the like. Thus, originally, a user dialed up a telephone number, the computer connected to another computer, and the two computers communicated through a communications application built upon some proprietary or standardized protocol. Thus, companies like Compuserve, GE Net, and America Online, became prominent as an industry through subscribers who dialed up to get access to computer resources.

Today, dial-up systems still exist. Dial-up systems are still popular among individual users. However, many enterprises (companies, organizations, foundations, and the like) may rely on a central server to provide access to the Internet for all users on a local area network or wide area network served by the enterprise server owned by that company. Meanwhile, the browser has become available as a suitable alternative to proprietary, esoteric, difficult, temperamental, access communication packages.

Regarding content, the Internet has brought a further substantial change. In addition to the browser being a ubiquitous application easily launched, and easily navigated by the most unsophisticated users, the value of placing content in communication with the Internet has become big business. “Company.com names” abound. Old line industries have developed “web sites” to host graphic illustrations of their products, their catalogs, their services, their personnel, and any other information that may be useful. Research sites abound, services sites abound, providing all types of information and assistance. Much of the Internet content is supported by advertising dollars. That is, banner ads, framed ads, and many types of visual media are placed periodically or permanently in the view of a user who is accessing services from a service provider of Internet content. In summary, the Internet has become a free-for-all information exchange.

Mass adoption of the Internet and broad use of Internet browsers have encouraged software developers to use the Internet to deliver applications to users. The protocol used on the Internet, HTTP, and the associated language for describing the look of Web pages, HTML, were designed primarily for publishing static material. User interaction is limited to facilitate the publication of information to large numbers of users, while giving the appearance of simultaneous interactive access.

Computer software applications generally consist of a repeating cycle of accepting input, performing processing on that input, and outputting the results of that processing. The input commonly comes from a combination of user input (such as the mouse and keyboard) and data input (such as from a file, database, or network connection). In the IBM-compatible PC environment, the user input and output devices are connected directly to the computer running the application. Thus, applications are generally designed to have the user physically present at the computer that is running (executing) the application.

As applications have become more sophisticated, they have evolved to be closely integrated with other applications. Instead of building an application that performs all of its own processing, applications can use the services of other applications. For example, consider a data entry application on a workstation that accesses a database that is on a server. The prevalent “client-server” architecture is for the data entry application to communicate with a database access application on the same workstation, which in turn will talk to a database application on the server, which then will access the data.

This architecture of “applications using applications” allows applications to be split into smaller components that can be used by other applications. The downside is that as a prerequisite to running an application, all of the component or resource applications that it uses must also be properly installed and configured on the computer. This can result in very complex setup/installation procedures for some applications. In addition, the setup and configuration of some applications is incompatible with other applications, or easily disturbed by the end user. In addition updates and upgrades must often be installed manually. This can be time consuming for sites having a large number of application installations.

Deploying applications to a large number of computers presents a significant problem. If the setup and configuration process is successful every time, it is often a significant task to perform this process on each computer that must have the application. But even a very small percentage of incompatibilities or installation failures can be a huge problem, often requiring expensive manual correction by a technician. And when an installation is successful, future installations of other applications can cause incompatibilities and failures. In practice, these are constant problems for organizations that have many computers.

With the growing popularity and sophistication of networks and the Internet, it has become possible to provide server-side processing to computer users. Server-side processing allows a user to execute applications on a more powerful remote server. This allows a user to execute applications requiring more processing power than is available from a users computer. Server-side processing also allows for centralized management of applications.

As software has become more functional and sophisticated, it has also become more complicated and difficult to understand. To be competitive, software must provide a rich, graphically intensive interface to make the software easier to use. This often involves monitoring the user's progress, and offering assistance or help based on the operation being performed by the user, or auto-completing an operation for the user. Often an application will encounter a situation where additional information is required before processing can continue. An example of this technology would be a “Yes/No” dialog box to confirm the deletion of a database record. In a server-side processing environment it is difficult to provide this functionality to a user at the same level of responsiveness. Many technologies attempt to provide this functionality but none adequately provide the level of interactivity and responsiveness that computer users expect. Following is a summary of the current major technology solutions.

Typed keystrokes are transmitted to software on a host. The host responds by outputting text. The terminal may be local or remote. The output text may include “control characters” for drawing boxes, and the like on the terminal. Text terminals were the standard user interface for early computing, formed the basis for Bulletin Board Systems, and is still used heavily in UNIX environments. The user interface is very limited, and relatively poor when compared to a graphical environment. Text terminals do allow an application to be executed and operated remotely.

HTML is a text formatting language. A common configuration is for an application to be invoked and run on a server. Once the application has produced output, the application formats the output using HTML and transmits the output for display in a browser, typically on a user's remote computer. By structuring the application to respond to different input with different kinds of output, HTML can be used to build pseudo-applications. These HTML applications (or “weblications”) typically provide only limited interactivity with the user, and typically consist of repeatedly invoking an application on the server.

Thin-client approaches operate by painting application output to a memory buffer on the server, then sending “pictures” of this output as it changes.

Java is a programming language that is platform independent, so it can run on many different platforms. Java applications can be easily and automatically downloaded, and can provide a graphical user interface. Java applications execute fully on the client, and present the user interface on the computer that is executing the application. Java is often used for client-server applications.

Client-server models consist of a client application that executes on the user's computer, and a server application that executes on the server. The client and server may exchange information, such as database records.

The screen sharing technologies consist of a client application and server application. The client application on the user's computer connects to the server application on the remote computer. The client application sends keystrokes and mouse movements to the server, and the server sends screen shots to the client.

In an X-windows architecture, applications, which may be running on a remote computer are expressly written and compiled to make API calls to an X client on the server. The X client sends the API calls to a user's computer running an X server which is connected to a display and input devices. The X server manages all user interface and display capabilities. Main frame base architectures provide a means for applications to interface with a user (remote or local) graphically. Is not an “application server” environment. Used as a UI enhancement in text terminal environments.

What is needed is a new system for executing an application installed on an application server and which is invoked and controlled by a user who is physically at a different computer. It would be an advancement in the art if such an application may make use of computing resources on both the user's computer and the server. It would be an advancement in the art if such a system were able distribute the execution of an application between the user's computer and the application server without requiring the modification of the application. Such a system would require less data to be sent across the network. It would also reduce the computing load of the application server. Such a system would also preferably provide a user interface that behaves much the same as it would if it was physically running on the user's computer (e.g., provide rich color schemes).

It would be an advancement in the art if the system obviated the need for rewriting of computer code to customize software applications for a given environment. It would be a further advancement in the art if such a system allowed multiple users to interact simultaneously with the same running application. Moreover, such a system would enable multiple users to use the same or different software applications from the same server or group of servers, and such a system would enable a single user to use software applications from multiple servers or groups of servers.

It would further be an advancement in the art to provide an application program that would execute entirely on a server computer and enable one remote user to see and control the screen of a second remote user. Such a system would preferably include apparatus and methods that provide the ability for multiple users of an application to use a single instance of the application. Such a system would preferably include the ability for multiple users to enter the single instance of the application program at different entry points, thereby causing the application program to provide a functionality to a first remote user while providing a distinct functionality or functionalities to the second and subsequent remote users.

### BRIEF SUMMARY AND OBJECTS OF THE INVENTION

In view of the foregoing, it is a primary object of the present invention to provide a method and apparatus for serving software applications that would enable the software application to execute on the server station, while the processing of interface and other elements of the software application is performed primarily by a workstation, which is typically remote from the server station.

Consistent with the foregoing object, and in accordance with the invention as embodied and broadly described herein, an apparatus and method are disclosed in one embodiment of the present invention in which a computer software application executes on one computer (the “server station”), while the software is controlled and operated by a user at another computer (the “workstation”). In certain embodiments, apparatus and methods in accordance with the invention require no cooperation from the application. Apparatus and methods in accordance with the invention may virtualize the user interface devices (e.g., keyboard, mouse, and output devices) to the application and may recreate the presented interface to the user in its native form. Apparatus and methods in accordance with the invention may process interface elements primarily on a workstation, while the functionality of such apparatus and methods may be controlled by a software application running on the server station.

Certain embodiments of apparatus and methods in accordance with the invention support multiple users running multiple, simultaneous instances of the same or different software applications from a single server or group of servers. In selected embodiments, software applications may be enhanced to cooperate with apparatus and methods in accordance with the invention to create multi-user applications capable of instantly sharing data and presenting that data among multiple users (i.e. collaborative applications). Apparatus and methods in accordance with the invention may provide a means by which a software application can execute on a server, and interact intensively over a network with an end user (using a workstation), without the software application being installed and configured on the workstation. Apparatus and methods in accordance with the invention may enable applications to continue to provide a very rich user experience by not restricting the application to a “lowest common denominator” of capabilities that can be supported by all possible platforms (such as handheld computers, PCs, Macintosh, and the like).

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of one architecture for a hardware suite suitable for implementing an apparatus in accordance with the invention;

FIG. 2 is a schematic block diagram of various configurations of users and servers accessing the Internet through ISPs, along with implementation schemes for implementing apparatus and methods in accordance with the invention;

FIG. 3 is a schematic block diagram of data structures suitable for implementing at least one embodiment of a service module in accordance with the invention;

FIG. 4 is a schematic block diagram of data structures suitable for implementing at least one embodiment of a server module in accordance with the invention;

FIG. 5 is a schematic block diagram of data structures suitable for implementing at least one embodiment of a client module in accordance with the invention;

FIG. 6 is a schematic block diagram of data structures suitable for implementing at least one embodiment of a central services module in accordance with the invention;

FIG. 7 is a schematic block diagram of one embodiment of a software architecture and hardware architecture for implementing at least one embodiment of an apparatus and method in accordance with the invention;

FIG. 8 is a schematic block diagram illustrating the functionality of an intermediate module and data structures suitable for implementing a system object management module in accordance with the invention;

FIG. 9 is schematic block diagram of the process of API call redirection in accordance with the invention;

FIG. 10 is a schematic block diagram detailing an object management module and a client object management module in accordance with the invention.

FIG. 11 is a schematic block diagram of a predictive emulation module and a predictive emulation client in accordance with the invention;

FIG. 12 is a schematic block diagram of a predictive emulation module and predictive emulation client configured to predictively emulate menus and fonts in accordance with the invention;

FIG. 13 is a schematic block diagram of data structures suitable for launching an application in accordance with the invention;

FIG. 14 is a schematic block diagram of an application having multiple entry points;

FIG. 15 is a schematic block diagram of an implementation of a subscriber application in accordance with the invention;

FIG. 16 is a schematic block diagram of data structures suitable for implementing a subscriber application in accordance with the invention;

FIG. 17 is schematic block diagram of a method for connecting to a subscriber application in accordance with the invention;

FIG. 18 is a schematic block diagram of an alternative method for connecting to an application having multiple entry points, in accordance to the invention;

FIG. 19 is a schematic block diagram of a method for using an application having multiple entry points, in accordance with the invention;

FIG. 20 is a schematic block diagram of a method for managing objects in accordance with the invention;

FIG. 21 is a schematic block diagram of a method for performing predictive emulation, in accordance with the invention; and

FIG. 22 is a schematic block diagram of a method for launching an application in accordance with the invention.

### DETAILED DESCRIPTION OF THE PREFERRED EMBODIMENTS

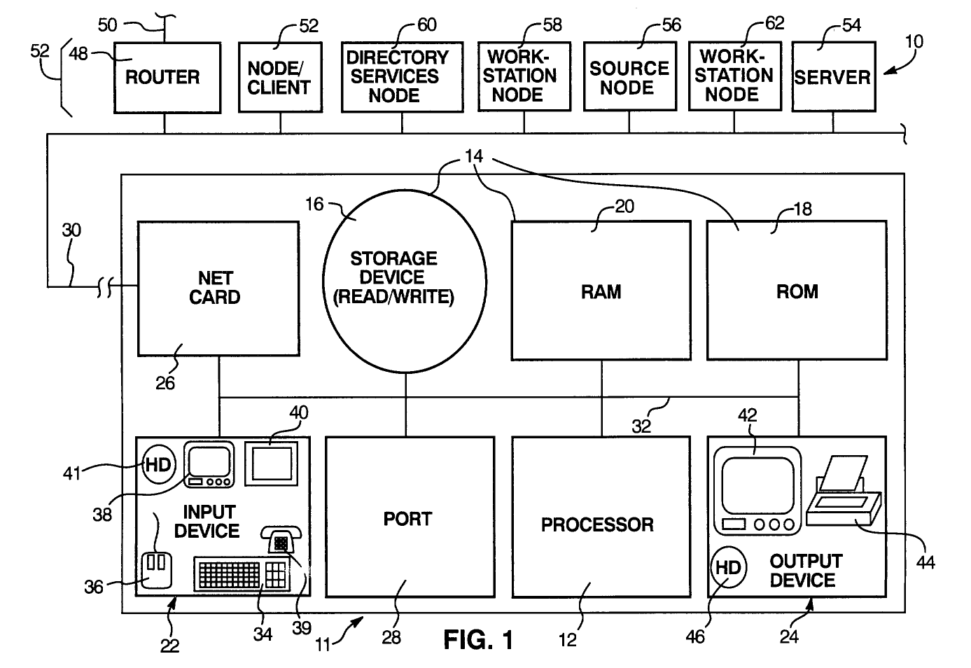

It will be readily understood that the components of the present invention, as generally described and illustrated in the Figures herein, may be arranged and designed in a wide variety of different configurations. Thus, the following more detailed description of the embodiments of the system and method of the present invention, as represented in FIGS. 1 through 17 and appendix A, is not intended to limit the scope of the invention, as claimed, but it is merely representative of the presently preferred embodiments of the invention.

The presently preferred embodiments of the invention will be best understood by reference to the drawings, wherein like parts are designated by like numerals throughout.

Those of ordinary skill in the art will, of course, appreciate that various modifications to the details illustrated in the schematic diagrams of FIGS. 1-22 may easily be made without departing from the essential characteristics of the invention. Thus, the following description is intended only as an example, and simply illustrates one presently preferred embodiment consistent with the invention as claimed herein.

Referring to FIG. 1, an apparatus 10 may include a node 11 (client 11, computer 11) containing a processor 12 or CPU 12. The CPU 12 may be operably connected to a memory device 14. A memory device 14 may include one or more devices such as a hard drive 16 or nonvolatile storage device 16, a read-only memory 18 (ROM) and a random-access (and usually volatile) memory 20 (RAM).

The apparatus 10 may include an input device 22 for receiving inputs from a user or another device. Similarly, an output device 24 may be provided within the node 11, or accessible within the apparatus 10. A network card 26 (interface card) or port 28 may be provided for connecting to outside devices, such as the network 30.

Internally, a bus 32 (system bus 32) may operably interconnect the processor 12, memory devices 14, input devices 22, output devices 24, network card 26 and port 28. The bus 32 may be thought of as a data carrier. As such, the bus 32 may be embodied in numerous configurations. Wire, fiber optic line, wireless electromagnetic communications by visible light, infrared, and radio frequencies may likewise be implemented as appropriate for the bus 32 and the network 30.

Input devices 22 may include one or more physical embodiments. For example, a keyboard 34 may be used for interaction with the user, as may a mouse 36. A touch screen 38, a telephone 39, or simply a telephone line 39, may be used for communication with other devices, with a user, or the like.

Similarly, a scanner 40 may be used to receive graphical inputs which may or may not be translated to other character formats. A hard drive 41 or other memory device 14 may be used as an input device whether resident within the node 11 or some other node 52 (e.g., 52, 58, etc.) on the network 30, or from another network 50.

Output devices 24 may likewise include one or more physical hardware units. For example, in general, the port 28 may be used to accept inputs and send outputs from the node 11. Nevertheless, a monitor 42 may provide outputs to a user for feedback during a process, or for assisting two-way communication between the processor 12 and a user. A printer 44 or a hard drive 46 may be used for outputting information as output devices 24.

In general, a network 30 to which a node 11 connects may, in turn, be connected through a router 48 to another network 50. In general, two nodes 11, 52 may be on a network 30, adjoining networks 30, 50, or may be separated by multiple routers 48 and multiple networks 50 as individual nodes 11, 52 on an internetwork. The individual nodes 52 may have various communication capabilities.

In certain embodiments, a minimum of logical capability may be available in any node 52. Note that any of the individual nodes 52 may be referred to, as may all together, as a node 52 or nodes 52.

A network 30 may include one or more servers 54. Servers may be used to manage, store, communicate, transfer, access, update, and the like, any number of files for a network 30. Typically, a server 54 may be accessed by all nodes 11, 52 on a network 30. Nevertheless, other special functions, including communications, applications, and the like may be implemented by an individual server 54 or multiple servers 54.

In general, a node 11 may need to communicate over a network 30 with a server 54, a router 48, or nodes 52. Similarly, a node 11 may need to communicate over another network (50) in an internetwork connection with some remote node 52. Likewise, individual components of the apparatus 10 may need to communicate data with one another. A communication link may exist, in general, between any pair of devices or components.

By the expression “nodes” 52 is meant any one or all of the nodes 48, 52, 54, 56, 58, 60, 62, 11. Thus, any one of the nodes 52 may include any or all of the component parts illustrated in the node 11.

The directory services node 60 provides the directory services as known in the art. Accordingly, the directory services node 60 hosts the software and data structures required for providing directory services to the nodes 52 in the network 30 and may do so for other nodes 52 in other networks 50.

The directory services node 60 may typically be a server 54 in a network. However, it may be installed in any node 52. To support directory services, a directory services node 52 may typically include a network card 26 for connecting to the network 30, a processor 12 for processing software commands in the directory services executables, a memory device 14 for operational memory as well as a non-volatile storage device 16 such as a hard drive 16. Typically, an input device 22 and an output device 24 are provided for user interaction with the directory services node 60.

In general, any number of workstation nodes 58, 62 may exist in a network 30, within some practical limit. Any network 30, 50 may be part of, and connect to the Internet 72.

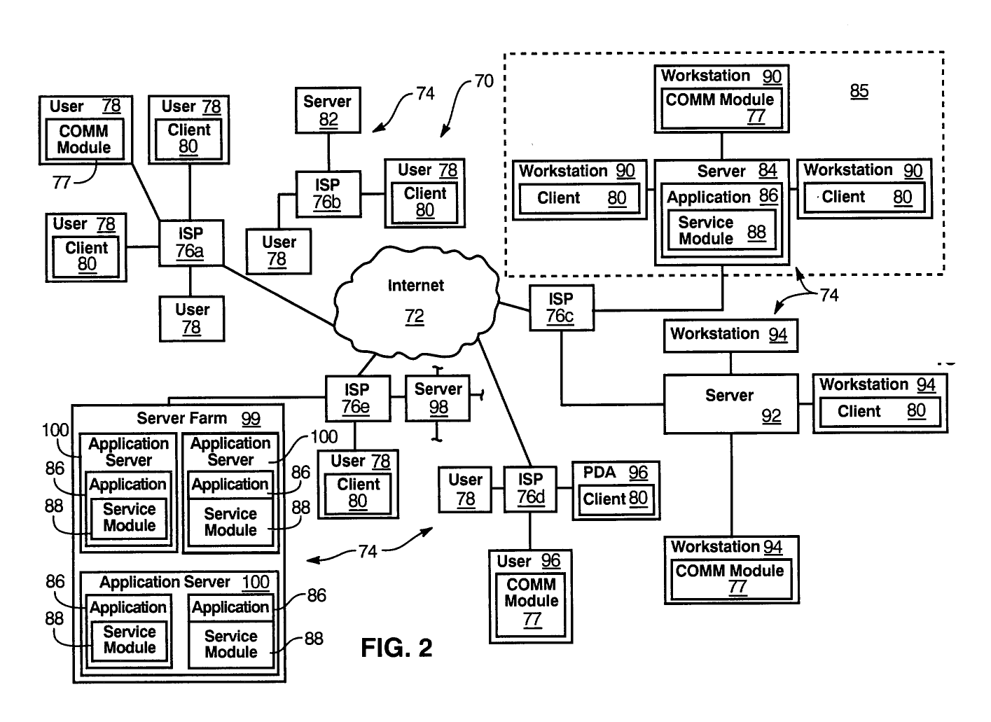

Referring now to FIG. 2 while continuing to refer to FIG. 1, a system 70 may include the Internet 72, or be connected to the Internet 72. In general, various other networks 74 may connect through Internet Service Providers 76 (“ISPs”) to the Internet 72, and ultimately to each other. The reference numerals 76 include various individual ISP entities 76a-76e. In general, any of the individual ISPs 76 may connect to a plurality of individual users 78. Individual users 78 may communicate over the Internet 72 using a browser application (not illustrated). Individual users 78 may host on a computer 11, a client module 80 or a Comm module 77. Preferably, the client 80 is configured to communicate with the service modules 88. Alternatively, a Comm module 77, which is typically configured in accordance with the “thin client” model, may be configured to communicate with the service modules 88. A client module 80 may also be hosted on an individual computer 11 used by an individual user 78. The user 78 connects to the Internet 72 through an ISP 76a, which may serve other users 78, or other enterprise computer systems, gateway computers, proxy servers, and the like for Internet access by LANs or WANs.

In one alternative embodiment, a server 82 may connect to the Internet 72 through an ISP 76b. The server 82 may be configured to serve as a central store of configuration information, profiles, templates, certification information, associations, authorizations, and the like. Of course, a plurality of users 78 may also connect to the Internet 72 through the ISP 76b.

In one alternative embodiment, a server 84, which may be an enterprise server 84, may connect to the Internet 72 through an ISP 76c. The server 84 may support several workstations 90 connected in a network 85. The network 85 may be a local area network (LAN) or a wide area network (WAN), or the like. In certain embodiments, the server 84 may be an application server 84 and may host thereon an application 86. The application 86 may be any software application. The server 84 may serve the application 86 across networks 74 to include the Internet 72. In selected embodiments, a server 84 may host a service module 88 to provide, in conjunction with one or more client modules 80, functionality in accordance with the invention.

Accordingly, in the embodiment of the server 84 in the network 85, a service module 80 operates on the enterprise server 84. Meanwhile, a client portion 80 or service client 80 operates on each workstation. A client may be thought of as any computer or software module that accesses resources stored on a server over a network connection. Accordingly, the actual execution of the various required functions in accordance with the invention may be accomplished on either the server 84 or the workstation 90, depending how the responsibilities are divided in an appropriate architecture to optimize speed, storage, reliability, and so forth. A service module 88 may be configured to monitor, modify, or emulate Application Programming Interface (API) calls of an application 86, thereby to provide functionality in accordance with the invention.

In one embodiment, a server 92 may be configured to support a local area network 74 made up of workstations 94. In one embodiment, the same hardware, through appropriate software may operate as a proxy server 92, providing Internet access to each of the workstations 94. Accordingly, the overall computer system or enterprise network 74 may rely on the proxy server 92 as a gateway to the Internet 72. The proxy server 92 relies on an ISP 76c to provide access to the Internet 72. Accordingly, the proxy server 92 or enterprise server 92, realize the functions of network server and proxy server, although typically both may be hosted on a single hardware computer, or multiple hardware computers, at will. A Comm module 77 or a client module 80 may communicate across the Internet to access any service module 88 depicted in FIG. 2 to provide the functionaliteis in accordance with the invention.

In another alternative embodiment, an ISP 76d may provide access to the Internet 72 to a personal digital assistant (“PDA”) 96. A client 80 and a Comm module 77 may be configured to be hosted on a PDA 96 to provide functionality in accordance with the invention to a user of a PDA 96. Of course, the ISP 76d may also concurrently provide access to the Internet 72 to other users 78.

In yet another alternative embodiment, a server farm 99 may connect to the Internet 72 through an ISP 76e. A server farm 99 may be thought of as a group of servers that are linked together as a single system image to provide centralized administration and horizontal scaleability. The server farm 99 may provide application server computing support to an enterprise or other selected entity or entities. Application server computing may be defined as a server-based approach to delivering applications to end-user devices. Benefits of application server computing include single-point management, universal application access, bandwidth-independent performance, and improved security for business applications. In certain embodiments, the server farm 99 may provide the functionalities in accordance with the invention.

The server farm 99 may be an Application Service Provider (“ASP”) farm 99. An ASP typically deploys, hosts, and manages access to an application, such as an application 86, to multiple users from a centrally managed facility. An ASP also typically delivers applications 86 over networks 30, 50 on a subscription basis. Moreover, ASPs are designed to speed implementation of new applications, minimize the expenses and risks borne over an application's life cycle, and ameliorate the problems associated with the current shortage of qualified technical personnel in the marketplace.

The embodiment of the server farm 99 may include an application server 100, or server station 100, for serving applications 86. The server farm 99 may host one or more applications 86 and one or more service modules 88. Applications 86 may include any application designed for execution on a general purpose computer 11 including without limitation word processing programs, spreadsheets, database programs, accounting programs, Internet browsers, and the like. Although not illustrated, a server farm 99 also typically includes a plurality of web servers configured to serve files across Internetwork connections. A web server is typically associated with caches of files received across network connections, which are stored to be served across network connections to remote web servers or clients.

Since the server farm 99 may provide any application 86 from word processing to graphics engines, to specialized commercial software, a service module 88 may be hosted by the server farm 99, in order to provide functionality in accordance with the invention.

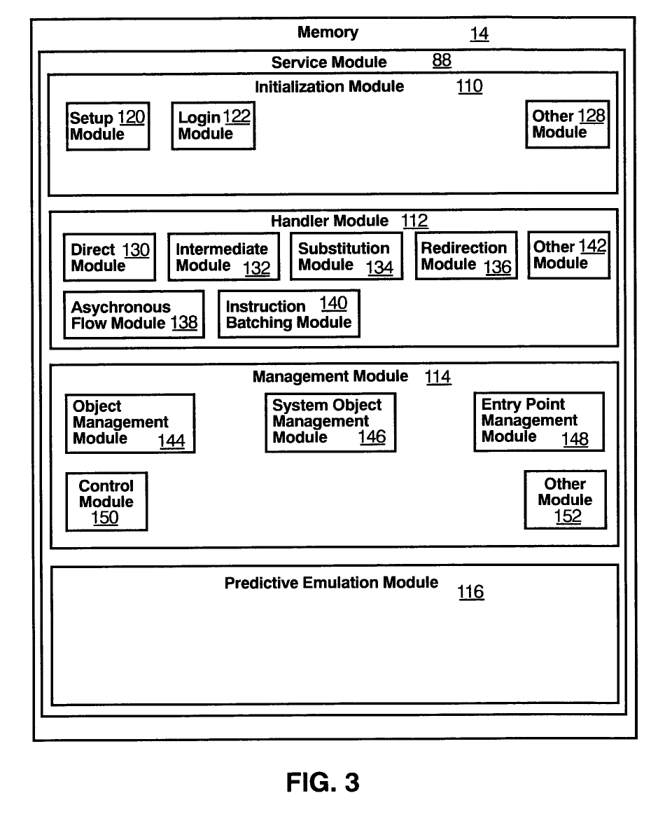

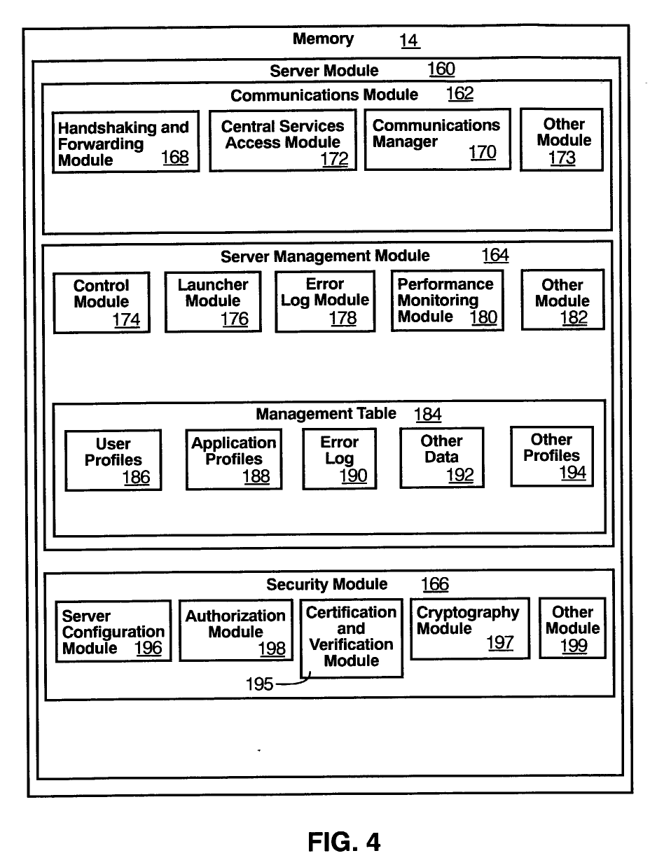

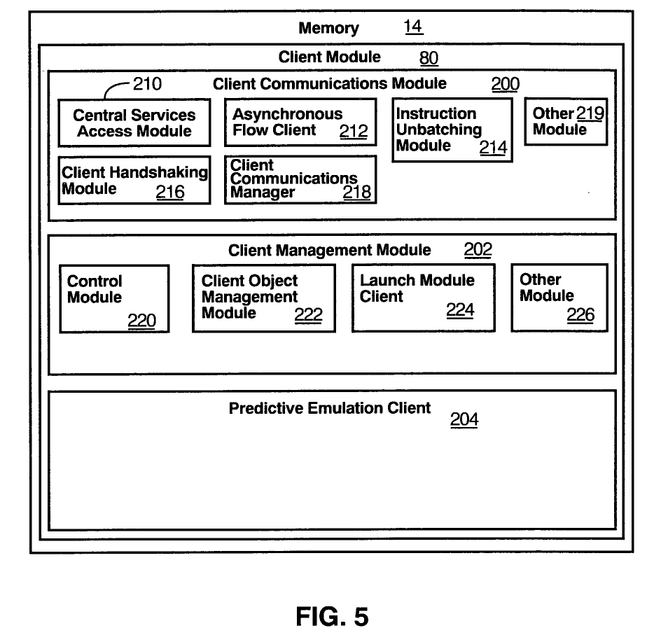

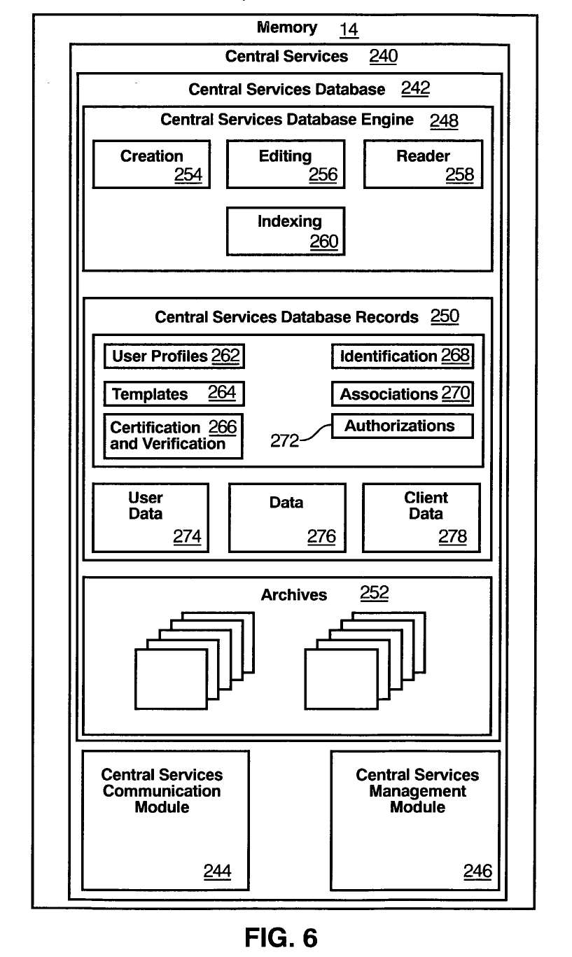

In one embodiment, the present invention may include the following modules: a service module 88 (FIG. 3), a server module 160 (FIG. 4), a client module 80 (FIG. 5), and a central services module 240 (FIG. 6). In a typical embodiment the service module 88 resides on the same server 82, 84, or server farm 99 as the server module 160. The central services module 240 is entirely optional. It may reside on the same server 82, 84 or server farm 99 as the service module 88 and server module 160. It may also reside on a entirely different computer connected to the server 82, 84, or server farm 99 through a network 30. Typically the apparatus 10 will provide the same functionality independent of the location of the service module 88, client module 80, and server module 160. For exemplary purposes, the service module 88 and server module 160 are discussed as residing on a server station 100 and the client module 80 is discussed as being installed on a workstation 94. A wide range of equivalents to the following description are possible. A workstation 94 may be replaced with a user computer 78, or workstation 90 for the following discussion. Likewise, a server station 100 may be replaced by a server 84, 92, 98, or the like.

Referring to FIG. 3, while referring generally to FIGS. 4 and 5, in one embodiment a server station 84, 92, 98, 100 may have a memory device 14, which may store a service module 88 and an operating system 15. A memory device 14 embodied in volatile or nonvolatile memory, and whether or not embodied in one physical location or multiple physical locations (e.g., one or more servers), in a computer 11, which computer 11 may be disposed in any of the configurations of FIG. 2, may host a service module 88 having an initialization module 110, a handler module 112, a management module 114, and an emulation module 116.

In one embodiment, the initialization module 110, as every other module in accordance with the invention, may be any thing from a single machine-level instruction, to an entire multimedia application. That is, an individual module in accordance with the invention (e.g. modules 80, 88, 160, and the like) as well as all sub-modules thereof can physically be stored in any size, shape, configuration, on any number of computers, in order to execute its function. Thus, the initialization module 110 is that code that is logically executed in order to effect the initialization process in preparation for the software modules described and disclosed herein to provide the functionality in accordance with the invention. The initialization module 110 typically includes a setup module 120 and a login module 122. Other modules 128 may be created to provide other services or to support the initialization process.

A setup module 120 typically prepares an application 86 and a service module 88 to run an application 86. A login module 122 may perform authentication, such as accepting, and verifying passwords, before allowing a user to access service module 88 resources.

The handler module 112 typically handles API calls in accordance to the invention. The present invention may alter the handling of API calls from that for which the application was originally designed. The handler module 112 may intercept API calls and deal with them in a number of ways. The handler module 112 typically includes a direct call module 130, an intermediate call module 132, a substitution module 134, a redirection module 136, an asynchronous flow module 138, an instruction batching module 140, and other modules 142. The direct call module 130 may allow an API call to be executed by the operating system 15 of the server station 100 without modification.

The intermediate call module 132 may perform certain operations on an API call before passing it to the operating system 15. In one embodiment the intermediate module 132 may modify the parameters passed into an API call before passing it to the operating system 15. The intermediate module 132 may also pass an alternative API call to the operating system 15. The intermediate module 132 may also modify or replace the parameters originally passed to the API call.

The substitution module 134 may replace an API call with an alternative function call. The substitution module typically does not pass any API calls to the operating system 15. The redirection module 136 may redirect an API call such that it is executed as a Remote Procedure Call (RPC) by the client module 80. A RPC is a message sent from the service module 88 to the client module 80. A RPC contains information sufficient to instruct the client module 80 to execute a particular function. A RPC may also contain parameters to be passed to a particular function.

The asynchronous flow module 138 in conjunction with the asynchronous flow client 212 (FIG. 5) residing in the client module 80 may control the rate at which data is sent to the client module 80. The asynchronous flow module 138 and asynchronous flow client 212 may assure that data is sent to the client module 80 at the same average rate at which the client module 80 processes it. In one embodiment, an asynchronous flow module 138 may record how many RPC's have been sent to a client module 80. The asynchronous flow client 212 may respond periodically, communicating to the asynchronous flow module 138 how many RPC's it has processed. The asynchronous flow module 138 may compare the number of RPC's sent to the number of RPC's processed. Based on this comparison the asynchronous flow module 138 may adjust the rate at which RPC's are sent so that the amount of data sent does not exceed the amount of data received by more than a certain allowable amount.

The instruction batching module 140 may group intercepted API calls that are to be sent by the redirection module 136 and other communicated data to the client module 80 such that they may be transported over the network as a single network packet, thereby reducing network traffic. The instruction unbatching module 214 may receive and process batches of instructions in order to prepare the individual API calls or communicated data to be processed by the client module 80. For example, many applications 86 make use of API calls which draw simple shapes to display, often, an application 86 will make many such API calls to render an image. The instruction batching module 140 may group these API calls into a single API call in order to reduce network traffic and to reduce the amount of processing necessary on a workstation 90, 94 or user workstation 78.

The management module 114 typically includes an object management module 144, and a system object management module 146. In selected embodiments, the management module 114 may also include an entry point management module 148 and a control module 150.

Applications often make use of objects defined and created by the operating system. In order for an application running on a server station 100 to provide user interface functionality on a remote workstation 94, the operating system 15 of the workstation 94 typically requires the creation of some objects on the workstation 94. It would create a great deal of network traffic to transfer all the data associated with such an object to the application 86 for storage or for access by the application 86, accordingly the object management module 144, in conjunction with the client object management module 222 may maintain corresponding sets of objects on the server station 100 and on the workstation 94. In this manner only data that is changed need be transferred in order to maintain the consistency of data between the two sets of objects.

The entry point management module 148 may allow a user to connect to a particular entry point of an application 86 having multiple entry points in accordance with the present invention. The entry point management module 148 may also maintain connections between users and entry points, allowing users to access data and functionality specific to their session with an application 86.

The control module 150 may coordinate all of the functionality of the service module 88, invoking the various modules and submodules thereof, in response to user input and any other relevant stimuli.

The predictive emulation module 116 and the predictive emulation client 204 of the client module 80 may perform predictive emulation, predictive emulation being providing the functionality normally provided by the application in response to user inputs or other stimuli. In a distributed processing environment it is best to decrease the amount of information passed across a network 30. Accordingly, predictive emulation reduces the need to constantly send user interface events to be processed by the application and the need to wait for the application to respond. Predictive emulation may involve anticipating the functionality of the application in response to user actions or other stimuli and emulating that behavior without waiting for a response from the application.

Referring to FIG. 4 while referring generally to FIGS. 3, 5 and 6, in one embodiment, an apparatus 10 may include a server module 160 stored in a memory device 14 residing on a server station 100. The server module 160 and service module 88 may be installed on the same server station 100, but need not be. A memory device 14, whether embodied in volatile or nonvolatile memory, and whether or not embodied in one physical location or multiple physical locations (e.g., one or more servers), in a computer 11, which computer 11 maybe disposed in any of the configurations of FIG. 2, may store a server module 160 having a communications module 162, a server management module 164, and a security module 166.

The communications module 162 typically includes a handshaking and forwarding module 168, a communication manager module 170, and a central services access module 172. Other modules 173 may be created to provide other services or to support the server communication processes.

The handshaking and forwarding module 168 may, in conjunction with a client handshaking module 216 of a client module 80, carry out communication between the server module 160 and a client module 80. In one embodiment a handshaking and forwarding module 168 and client handshaking module 216 may make use of a network protocol such as HTTP in order to establish a connection between a server module 160 and a client module 80.

The central services access module 172 may request data from a central services module 240 (FIG. 6) or send data to be stored therein. For example a central services access module 172 may report the amount of time a user used a particular application to a central services module 240, which may store it in a central services database for billing purposes. A central services access module 172 may also query a central services module 240 to verify that a user is allowed access to a particular application 86. A central services access module 172 may also access user files stored by a central services module 240.

The communications manager 170 may provide a means for a client module 80 to access data stored on the server module 160. The communications manager module 170 may also provide a means whereby data may be transferred between a client module 80 and a service module 88. The communications manager 170 may also function in conjunction with the client communications manager 218 to coordinate the transfer of data from the client module 80 to the service module 88.

A plurality of workstations 94 may connect to a server station 100 and they may be accessing a plurality of applications 86, accordingly the communications manager 170 may see that communications sent from a workstation 94 arrive at the correct application or entry point of an application, and that data from an application 86 arrive at the correct workstation 94. A client module 80 may handle a user's simultaneous access to multiple applications, accordingly, the client communications manager 218 may assure that data transferred from the communications manager 170 is associated with the correct application session on the workstation 94. The communications manager 170 may also assure that data sent from an application session on a workstation 94 arrives at the correct server station 100 and/or the correct instance of a server module 160.

The server management module 164 typically includes a control module 174, a launcher module 176, an error log module 178, and a performance monitoring module 180. Other modules 182 may be created to provide other services or to support the server management processes.

The server management module 164 may also be configured to store and maintain user profiles 186, application profiles 188, error logs 190, as well as other data 192 and other profiles 194 that support the server management processes and functions.

The control module 174 may coordinate all of the functionality of the server module 160, invoking the various modules thereof according to the instructions of the various modules and in response to user inputs and other inputs.

The launcher module 176 may function in conjunction with the launching module client 224 to enable a user to initiate loading and execution of an application. The launcher module client 224 of a client module 80 may request that a launcher module 176 send a description of the applications and entry points of applications available from a server station 100. The launcher module client 224 may also present a user with a menu of applications which can be invoked by a user. The launcher module client 224 may receive user selection of an application or entry point of an application and relay the user selection to the launcher module 176. The launcher module 176 may then cause the loading and execution of a selected application. The launcher module 176 may also cause the initiation of a session between the client module 80 and an entry point of an application.

For example, a user may be presented with a window containing icons which a user may click to execute an application on a remote server station 100. In one embodiment the launcher module 176 may present a web page viewable from a web browser or the like. The web page may contain links linked to the specific applications 86 or entry points of an application 86, which a user may invoke in order to cause the launcher module 176 to execute an application 86 or connect a user to an entry point of an application 86.

The launcher module 176 may also detect whether a workstation 94 has a client module 80 installed thereon. The launcher module 176 may also, in response to an application request from a workstation 94 whereon a client module 80 is not installed, download a client module 80 onto the workstation 94 and cause the client module 80 to be installed on the workstation 94. Upon installing a client module 80 onto the workstation 94 the launcher module 176 may initiate an application session between the downloaded client module 80 and the server 160. Initiating an application session may include invoking the operating system to load an application and a service module 88 into memory and begin executing. Initiating an application session may also include causing the communications manager 170 to set up communication channels between a client module 80 and a service module 88.

The error log module 178 may handle the storage and viewing of error messages output by running applications, other modules constituting this invention, and the like. The performance monitoring module 180 may monitor parameters critical to the performance of the server module 160. For example the performance monitoring module 180 may monitor the number of active application sessions and the amount of memory and processor time they are using.

The security module 166 typically includes a server configuration module 196, an authorization module 198, and a certification and verification module 195. In selected embodiments, the security module 166 may include a cryptography module 197 and other modules 199 that may provide other services or may support the security processes.

The server configuration module 196 may enable an administrator of a server station 100 to specify security measures for a server. Security measures may include permissions for accessing files or functionality of a server module 160. The server configuration module 196 may also enable an administrator to set up accounts which may include authentication and configuration data associated with a particular user or organization. The server configuration module 196 may also manage preparing applications to be accessed via the server module 160 The authorization module 198 may, given information identifying a specific user or workstation 94, query a central services module 240 or a database internal to the authorization module 198 in order to determine whether that user or workstation 94 is allowed access to applications available through a server module 160. The authorization module 198 may also query a central services module 240 or some other database in order to discover which applications a particular user or workstation 94 is allowed to access. The authorization module 198 may perform other functions in order to control access to services provided by the server module 160.

A certification and verification module 195 may include either or both functions in order to prevent unauthorized access to a server module 160. The functions differ slightly in that verification is often done by symmetric or asymmetric cryptographic key systems. Likewise, verification may be done by digital signatures. Certification typically refers to assuring under financial and other penalties, underwritten by a certification authority, that a fact, identity, content, or the like is true. Accordingly, a certification authority may certify through the certification and verification module 195, that each participant in a communication over the Internet 72 is indeed the individual person, computer, hardware, software, or human entity designated and indicated by computer communications. Such certification is not always easy, but may be enforced by numerous mechanisms. In certain embodiments, a certification authority may require, through a certification module 195, that an individual human being provide sufficient information, clearly documented over the Internet 72, facts sufficient to establish an identity. Accordingly, the certification module 195 may provide true binding between information, Internet content transferred, and individual human beings as well as hardware and software used, in order to establish responsibility, reliability, veracity, factual evidentiary support, or the like as required.

Another module that may provide additional services may be a cryptography module 197. Cryptography may be used to avoid sending information in the clear between computers involved in the application serving process in accordance with this invention. For example, access by third parties may be inadvisable. The cryptography module 197 may simply access a cryptographic engine which may be among the numerous existing technologies and architectures that perform cryptographic functions.

Referring to FIG. 5, in one embodiment, a memory device 14, whether embodied in volatile or nonvolatile memory, and whether or not embodied in one physical location or multiple physical locations (e.g., one or more servers), in a computer 11, which computer 11 may be disposed in any of the configurations of FIG. 2, a client module 80 may include a client communications module 200, a client management module 202, a predictive emulation client 204.

The client communications module 200 typically includes a client communications manager 218, a client handshaking module 216, and an instruction unbatching module 214. In selected embodiments, the client communications module 200 may also include a central services access module 210 and an asynchronous flow client 212. Other modules 219 may be created to provide other services or to support the client communication processes.

The central services access module 210 may provide a means such that a user may access data stored by a central services database 242. For example a user may be allowed space to store files in an archive 252 residing in a central services database 242. A central services access module 210 may provide a means to access those files.

The client management module 202 typically includes a control module 220, a client object management module 222, and a launcher module client 224. Other modules 226 may be created to provide other services or to support the client management processes. The control module 220 typically controls the execution of the other modules and submodules of the client module 80, invoking them when necessary. The control module 220 may also receive messages from the operating system 15 and forward them to the application 86.

Referring to FIG. 6, a central services server, such as a server 82, in accordance with the invention may be provided with registry and file storage capabilities. Such registry information may include user configuration data of users of the present invention. User configuration and customization data may be stored on the server such that the user configuration and customization information follows the user wherever the user logs on to a system in accordance with the invention.

For example, a memory device 14 whether embodied in volatile or nonvolatile memory, and whether or not embodied in one physical location or multiple physical locations (e.g., one or more servers), may be loaded with a central services module 240, which may include modules for supporting management and other associated functions related to a central services database 242. The central services module 240 may include a central services database 242, a central services communications module 244, and a central services management module 246.

The central services database may include a database engine 248, database records 250, and archives 252. In one embodiment, a database engine may have executable functionality amounting to a creation engine 254 responsible for establishing new records. Similarly, an editing module 256 may permit editing by an appropriate authorized individual accessing the database records 250. Similarly, the editing module 256 may have counterparts in other software, or may be the principal engine accessed by other interface modules in order to permit appropriate editing of database records 250 in accordance with selected authorization.

A database engine 248 may include a reader 258 and an indexing module 260 for creating and maintaining an indexing system. Additional functionality may be provided as known in the art for the database engine 248. Meanwhile, the database engine 248 may provide the principal executables, and selected APIs for various database interfaces requiring communications with the database records 250.

In general, the database engine 248 may be any commercial database engine, such as those produced under the current ODBC standards, the commercial products such as Oracle™, Sybase™, and others known in the art. The database records 250 may be those created in accordance with a schema, or hierarchy in any format, whether conventional, relational database, lists, object-oriented databases, or the like. Necessarily, the archive 252 must bear some relationship to the database records 250, and may rely on the same database engine or another.

Meanwhile, the archive 252 may be abstracted records, exact copies of records, marked records of the database records 250, or any appropriate data structures required to provide independent, and permanent control of the information in a database record 250 once it has garnered certain interest and a desire for being saved, or more permanently or securely stored.

The database records 250 may contain any suitable information determined by an architect of the database system 242. Accordingly, database records 250 may include, in each record, or in various records, information including user data 274, relating to individual users or workstations 94. Similarly, client data 278 may refer to customer information provided by users of services provided by the service module 88. A system in accordance with the invention may also include data 276, which may include any other data useful for registry, user configuration, and user customization data to users.

Database records 250 may also include user profiles 262, templates 264, certification and verification data 266, identification data 268, associations 270, and authorizations 272. User profile data 262 may include data pertaining to the users of apparatus and methods in accordance with the invention. Templates 264 may include pre-configured data or data structures useful in providing services to users of the invention. Certification and verification data 266 may contain cryptographic keys used for verification purposes and information needed to contact certification authorities.

Identification data 268 may include data identifying a user or identifying others associated with a user. Association data 270 may include any type of data indicating a user's association to the system, other users, or other entities. Authorization data 272 may include data indicating things that a user is authorized to do or places that a user is authorized to access.

Archive data 252 may also be stored on behalf of a user. A user may be provided with memory space on one or more servers in which the user may store archive data 252 of the user's choice. Such archive data 252 may include any type of electronic information or files that a user may desire to store.

A central services communication module 244 may establish and maintain network connections with other computers accessing information in the central services database 242. The central services management module 246 may control the execution of the various modules in the central services module240, invoking there functionality whenever required.

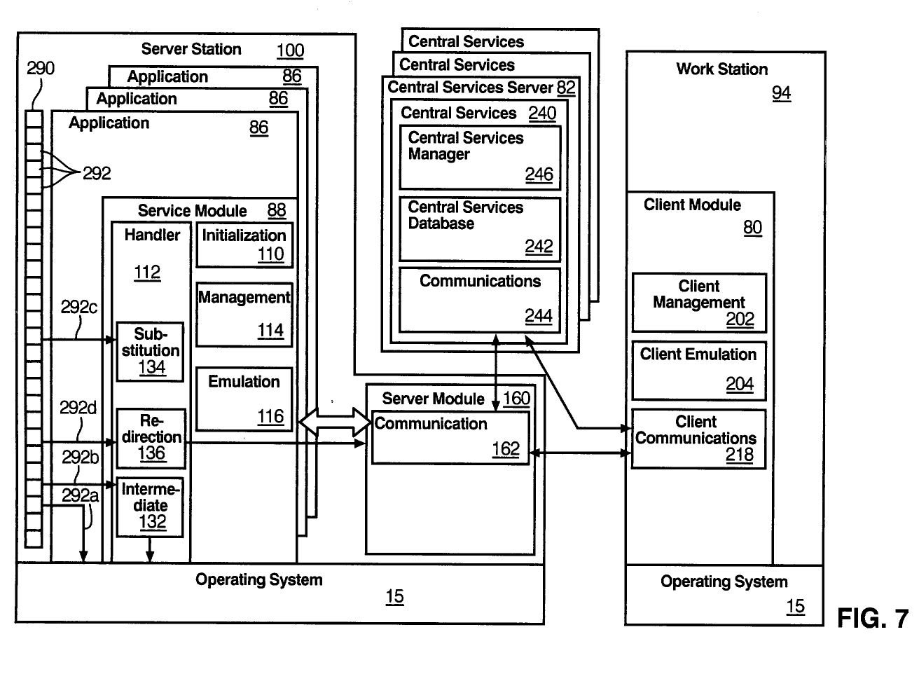

Referring to FIG. 7, an application server 100, which may be hosted at a server farm 99 or any of the servers 82, 84, and 92 may host one or more applications 86 and one or more service modules 88. The service module 88 may be configured to provide functionality in accordance with the invention in conjunction with one or more client modules 80, or comm modules 77 which may be hosted on one or more workstations 94 or user computers 78, or PDA 96. The service module 88 may provide functionality in accordance with the invention by intercepting API calls 292 to the operating system 15 running on the server station 100. Both the client module 80 and the server module 160 may have access to a central services server 82.

An application 86 may have an import table 290 providing a binding between the location of the executable and operational data associated with an API call 292 and the identifier of the API call used by the application 86. In some embodiments of the present invention the import table 290 may be modified such that the import table 290 indicates an alternative location of the executable and operation data associated with an API call 292. In some embodiments the import table may point to executable and operational data within the handler module 112. Accordingly, some API calls may be associated with functions within the direct call module 130, intermediate module 132, substitution module 134, or redirection module 136.

The service module 88 may provide functionality in accordance with the invention by performing a variety tasks. The service module 88 may monitor, modify, and/or emulate, as appropriate, API calls 292. For example, the service module 88 may permit a direct API call 292a to the operating system 15 without interceding in any way. This may simply mean that the import table 290 associates the expected executable data with that API call 292a.

Alternatively, API calls 292b may be directed to the intermediate module 132. The intermediate module 132 may perform selected processing of the API Call 292b before directing the API call 292 to the operating system 15 for disposition. The intermediate module 132 may modify the parameters passed to the API call 292b before passing it to the operating system 15. The intermediate module 132 may also pass an alternative API call to the operating system 15. The intermediate module 132 may also monitor API calls 292b as well as the parameters passed to them. The information gained through monitoring may be used by other modules such as the predictive emulation module 116 or object management module 144.

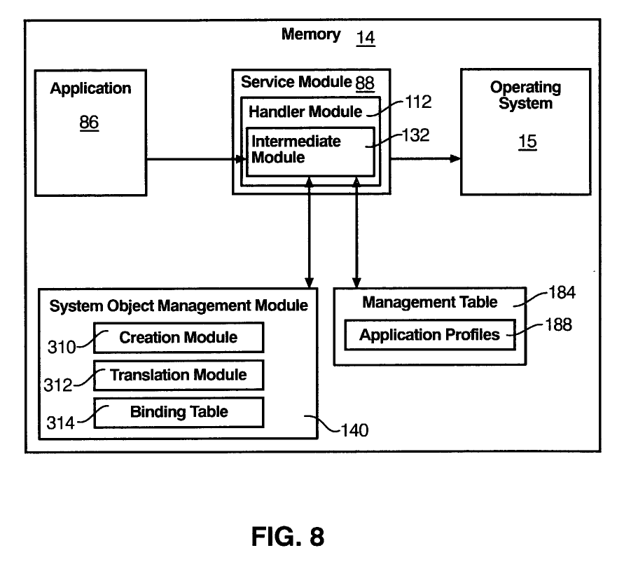

Referring to FIG. 8, in a multiple user environment, measures may need to be taken to assure that applications and users are prevented from accessing resources which are accessed by other applications or processes. Such resources may include threads and objects that have system wide scope. Accordingly the intermediate module 132 may translate attempts to create and access such system wide resources into API calls that are restricted to local resources associated exclusively with a service module 88 or executing application 86. In certain embodiments the intermediate module 132 may notify the system object management module 140 of attempts to create or modify system wide objects. The creation module 310 may create an alternative local object and provide an entry or record in a binding table 314 mapping the address or handle of the local object to the name the application associates with the expected system wide object. The translation module 312 may translate succeeding attempts to access the system wide object into API calls accessing the local object.

The management table 184 may include application profiles 188 which include files containing configuration data and other operational data used by an application 86. The application profiles 188 may be embodied as a memory mapped files rather than files stored on a storage device 16 such as a hard drive 16. This may reduce the time spent reading and writing data from the application profiles 188. The intermediate module 132 may translate an application's attempts to access files stored on a storage device 16 into attempts to access the application profiles 188.

The intermediate module 132 may also provide for restricted access to the file system of the server station 100. It would be undesirable to allow users to access files belonging to other users or to access system files. Accordingly the intermediate module 132 may intercept API calls 292 accessing the file system and only permit those accessing allowable files to be passed on to the operating system 15.

Referring again to FIG. 7, an API call 292c may be directed to the substitution module 134. The substitution module 134 may handle an API call 292c without passing a corresponding API call 292 to the operating system 15. The substitution module 134may intercept an API call 292c and do nothing. This may be because the predictive emulation module 116 and/or the predictive emulation client 204 have already anticipated the call 292c and emulated it. The substitution module 134 may do nothing because the API call 292c is not necessary. The predictive emulation module 116 and predictive emulation client 204 may determine this by monitoring the behavior of the application 86. Alternatively the substitution module 134 may be programmed to routinely ignore an API call 292c.

The substitution module 134 may also emulate an API call 292c, providing functionality normally provided by the operating system 15. The substitution module may be hard coded to emulate an API call 292c in a particular manner. Alternatively the predictive emulation module 116 may emulate the call.

The substitution module 134 may also intercept calls accessing, creating, or modifying objects which are stored on the workstation 94. The substitution may notify the object management module 144 of any such attempts in order that it may deal with them appropriately.

API calls 292d may be directed to the redirection module 136. The redirection module 136 may transform the API call 292d into a RPC, and transmit the RPC to the communications module 162 of the server module 160. Upon receipt of the RPC, the communications module 162 may perform additional processing of the RPC and associated data before transmitting the RPC 292 and associated data to the client communications module 218 of the client module 80, which typically resides on a workstation 94 or other user station 94.

The workstation 94 may host a client module 80. The client module 80 typically operates in conjunction with the service module 88 hosted on a server station 100 for providing functionality in accordance with the invention. Typically, the client communications module 218 receives a RPC sent to it by the communications module 162 and the redirection module 136 of the service module 88. Once the client module 80 receives a RPC, the client module 80 properly disposes of the RPC, which may include passing an API call 292 to the operating system 15 of the workstation 94.

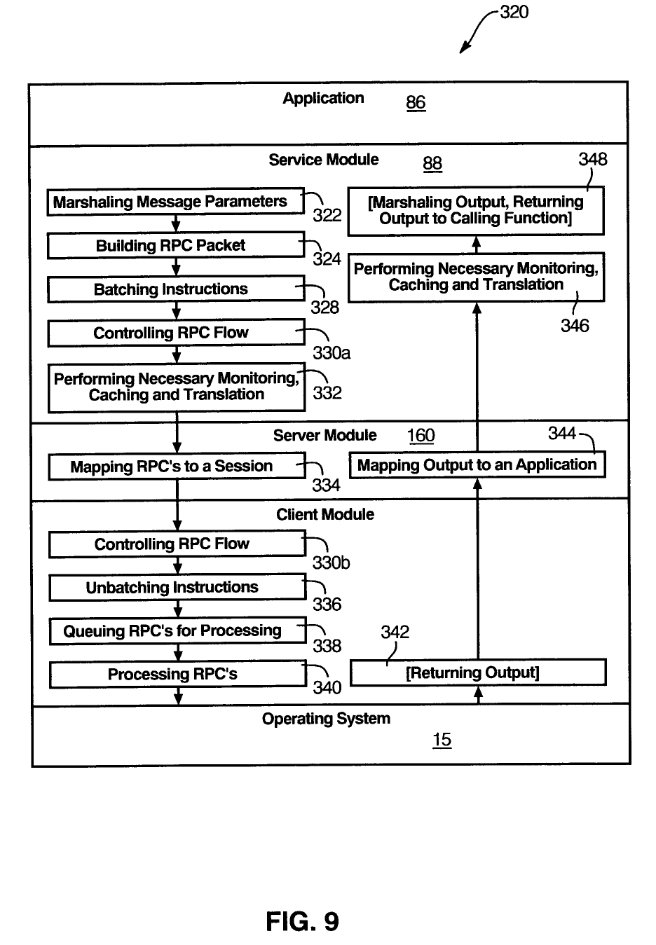

Referring to FIG. 9, RPC processing 320 may include marshaling 322 message parameters. Marshaling 322 may include assembling all the arguments passed to an API call 292d. Arguments are often passed to functions as pointers containing the address of the data being passed to the function. Such a pointer may be irrelevant to the operating system 15 of the workstation 94. Marshaling 322 may, accordingly, involve assembling the data to be transferred along with the RPC so that it may be used when the RPC is processed on the workstation 94.

Building 324 a RPC packet may involve packaging all the necessary arguments and information identifying the API call 292d that generated the RPC into a block of data arranged in a format that is recognized by the client module 80. Instruction batching 328 may involve grouping RPC's together so that they may be transferred to the client module 80 as a single network packet. The instruction batching module 140 may also group a plurality of API calls 292d into a single RPC if possible, thereby minimizing the amount of data that must be sent over the network 30 to the client module 80.

Controlling 330a,b RPC flow 32 may include assuring that, although RPC's are normally sent asynchronously, they are processed by the client module 80 at the same average rate at which they are sent. The processing of a RPC may require performing 332 monitoring, caching, and translation.

Mapping 334 RPC's to a session may include assuring that the RPC is associated with the correct session. The server module 160 typically records the applications that are running and a mapping between workstations 94 connected to the server 160 and running applications. A session is typically a mapping between a workstation 94 connected to the server station 100 and a running application, or an entry point of an application.

Unbatching instructions 336 may involve translating a batch of instructions sent by the instruction batching module 140 into individual RPC's. The RPC's may then be queued 338 for processing. An RPC may then be processed 340. Processing 340 may include passing an API call to the operating system 15.

Typically, the processing of an API call may produce a return value or modify some variable value. Accordingly the method 320 may include the step of returning 342 the output to the server module 160. The server may map 344 the output to an application to assure that the output is returned to the running application that caused the RPC to be generated.

The service module may then perform 346 further monitoring caching and translation of the output. Performing 332, 346 Monitoring may include monitoring the characteristics of the RPC's sent and the output returned. This information may be used by the predictive emulation module 116 and predictive emulation client to emulate application behavior. The object management module 144 and client object management module 222 may also make use of information gained through monitoring 332 and 346 to perform their function.

In order to minimize network traffic an apparatus 10 may store the same data on both a workstation 94 and a server station 100. Accordingly performing caching 332, 346 may include monitoring data that is attempted to be passed between the application 86 and the client module 80 and create caches of data on both the workstation 94 and server station 100 storing this information. This allows enables modules running on the server station 100 and client module 94 to access the data without waiting for it to be transferred across a network 30. Translation 332 may include changing the names of files referred to by a RPC. For example, a RPC may refer to a file that resides on the server. In order for the client module 80 to process the RPC, it must have that file. The server module 160 may cache a copy of the file on the workstation 94 and give it a name that ties it to a session and to the original file.

Versions of the same data may be stored on both the server station 100 and the workstation 94. The client module 80 and the service module 88 may refer to this data by different names. Accordingly, performing 332 translation may include translating RPC's having parameters that refer to data stored on the server station 100 to the corresponding parameters stored on the workstation 94. Performing translation 346 may include translating output referring to data stored on the workstation 94 to corresponding data stored on the server station 100. For example, for a file cached on the workstation 94, the service module 88 may translates all RPC's attempting to access the file stored on the server station 100 such that they instead refer to the file stored on the workstation 94.

Marshaling 348 output and returning 348 output to the calling function may include formatting the data returned 342 by the operating system 15 and providing it to the application 86 in the format expected by the application 86.

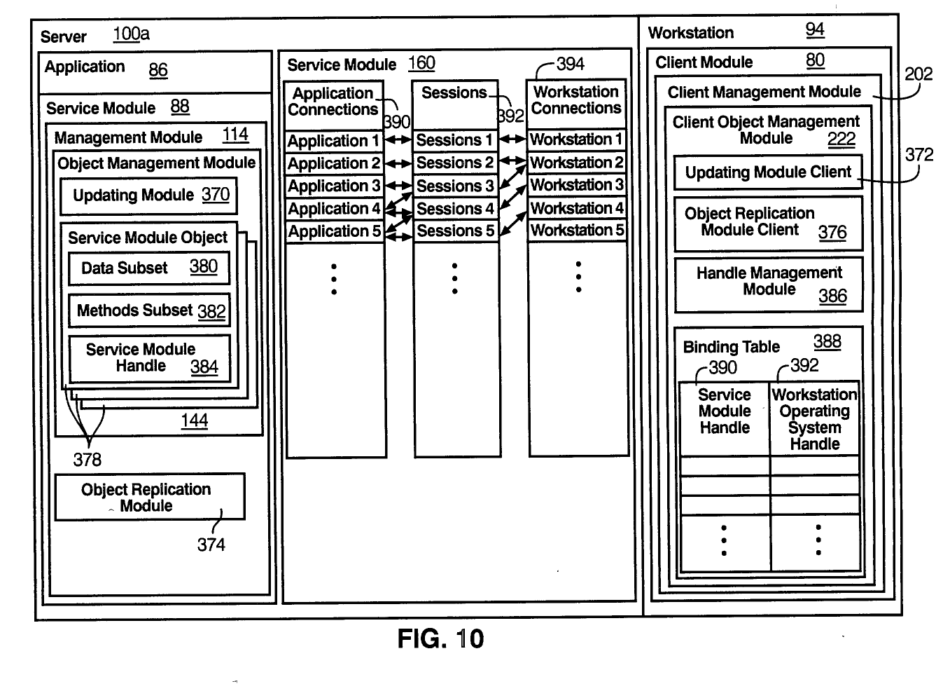

Referring to FIG. 10, applications typically require the operating system 15 to create objects providing some of the functionality of the user interface. Objects are typically user interface objects such as brushes, device contexts, and the like. In order for workstation 94 to display a user interface, these objects typically need to be available on the work station 94. The application 86 may also need to access the methods and data of these objects as well. In order to avoid having to transfer objects from the workstation 94 to the server 100, the object management module 144 and the client object management module 222 may maintain parallel sets of objects on both the server 100 and the workstation 94. The object management module typically stores service module objects 278 corresponding to the actual objects created by the operating system 15 of the workstation 94.

The updating module 372 may monitor intercepted API calls 292 and determine when critical objects are modified. Whenever the application 86 attempts to modify such an object, the updating module 370 may assure that both the service module object 378 and actual object are modified. Likewise, the updating module client 372 may monitor all attempts to modify critical objects stored on the work station 94 and assure that all necessary modifications are made to the service module objects 378.

The object replication module 374 may monitor intercepted API calls 292 which attempt to instantiate objects. The object replication module may create a service module object 378 and invoke the object replication client 376 to create a corresponding object on the workstation 94.

An application 86 may only need to access a service module object 378 having a data subset 380 and methods subset 382 of the data and methods of the actual object. Thus, only the data subset 380 need be updated. The methods subset 382 may include only those methods available to an application 86. The methods of the methods subset 382 may also be modified to provide functionality in accordance with the invention and to function in an application serving environment.

A service module object 378 may be assigned a service module handle 384 by the handle management module 386. A binding table 388 may maintain a mapping between service module handles 390 and workstation operating system handles 392. The client updating module 222 may make use of the binding table 388 to determine which service module object to update when its corresponding object is modified.

Applications 86 may have application connections 390 mapped to a session 392 associated with a workstation connection 394. Application connections 390 may identify running applications 86. A single session 318 may be thought of as a connection between an application 86 and a workstation 94 or client 80 residing on a workstation 94. In other words, a session 318 is a binding or mapping between a specific application 86 and a specific workstation 94. A single workstation connection 394 may be mapped to multiple sessions 392. Likewise, a single application connection 390 may have multiple sessions 392 associated therewith.

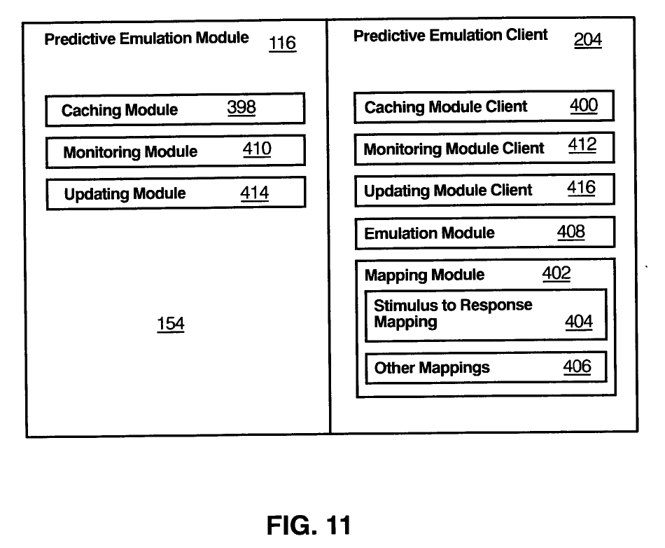

Referring to FIG. 11, Transferring data across a network 30 may introduce a very significant bottleneck in an application serving environment. To reduce this delay a predictive emulation module 116 and predictive emulation client 204 may anticipate the response of the application 86 to user interface events and other stimuli and emulate the application 86 behavior on the workstation 94.

In order to emulate application 86 behavior, the caching module 398 and caching module client 400 may maintain a cache of application data on the workstation 94. The mapping module 402 may maintain a stimulus to response mapping 404. The stimulus to response mapping 404 may record the response of the application 86 to user interface events or other stimuli. The mapping module 402 may also include other mappings 406 relating application behavior to situations, values of critical data or other criteria.

The emulation module 408 may make use of the data stored by the caching module client 400 and the mapping module 402 in order to emulate application 86 behavior in response to user interface events and other stimuli. This reduces the need for the client module 80 to wait for user interface events to be transferred across a network 30 to a server 100 and for the response of the application 86 to be returned. For example, if a user clicks on a menu in a menu bar a number of messages will be generated by the operating system. Often an application will ignore many of these messages or respond predictably to them. Accordingly a mapping between messages and application response to them, as well as cached data describing how the menu is to be displayed allows the emulation module 408 to display the menu and respond to messages, transferring only essential data across the network 30.

The monitoring module 410 may monitor intercepted API calls 292 and monitor the response of the application 86 to user interface events and the like. The monitoring module 410 may detect when critical data that has been cached on the workstation 94 has been changed by the application 86. The monitoring module 410 may also compare the response of the application 86 to that of the emulation module 408 and detect any differences therebetween. The monitoring module 410 may also monitor the application's 86 response to user interface events and the like in order to create a mapping to be recorded by the mapping module 402.

The updating module 414 may update cached data whenever the monitoring module 410 detect changes. The emulation module 408 may also be notified by the updating modules 410, 412 of any differences between the response of the emulation module and the response of the application 86. The emulation module may re-emulate the application behavior to conform more closely to that of the application 86. The emulation module may also re-emulate the application behavior to reflect updates made to the cached data. The emulation module may also undo any incorrect emulation operations.

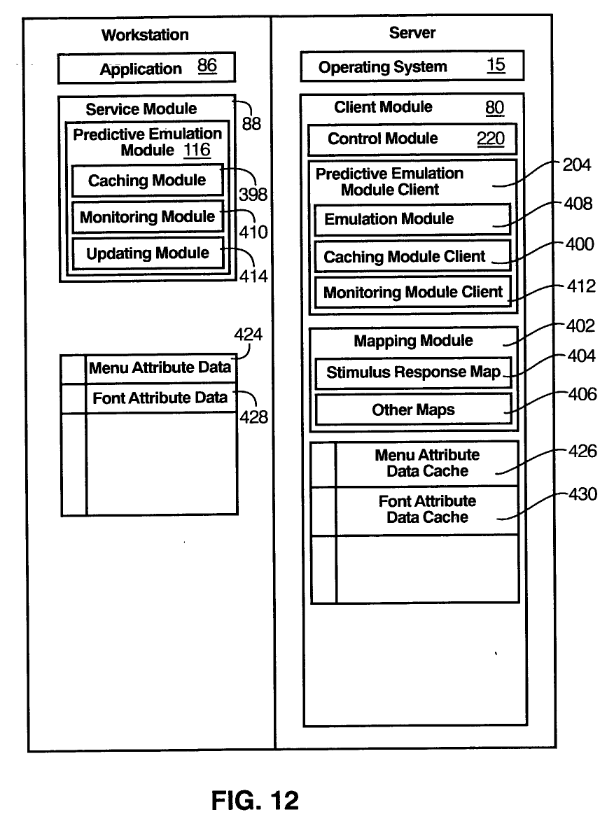

Referring to FIG. 12, an application typically provides a user interface having menus. Some menus may be defined in a resource file before the application 86 is launched, others are modified or created as the application is running. The process of a user selecting a menu item typically involves the user positioning the cursor over a menu item, clicking on the menu item, and choosing an item from the menu. Throughout this process the operating system 15 typically generates messages alerting the application 86 of what the user has done.

An application may or may not respond to these messages. The appearance of the menu may or may not change. Predictively emulating menu behavior provides a much more responsive user interface by reducing the time wasted sending messages to the application and waiting for a response. Predictive emulation typically involves anticipating the response of the application 86 and mimicking it, rather than waiting for the response to arrive.

The caching module 398 may send menu attribute data 424 of an application's menus to the caching module client 400 which may store it in a menu attribute data cache 426. Whenever the application 86 attempts to modify the menu attribute data 424, the updating module 414 will invoke the caching module client 400 to cache the modified menu attribute data 424 in the menu attribute data cache 426.

The monitoring module 410 and monitoring module client 412 may monitor the response of the application 86 to the messages generated in response to user interaction with menus. The mapping module 402 may then create a mapping indicating which messages the application 86 ignores and the messages to which the application 86 responds predictably along with data describing the application's 86 response. For example, an application may display a “help string” or helpful information when a user places the cursor over a menu item. The mapping module 402 may record what to display in response to messages indicating that the user has placed the cursor over a particular menu item.

When a user clicks on a menu item which invokes another menu, the operating system generates a message indicating this to the application 86. The emulation module may respond to this message by displaying the menu according to the menu attribute data cache 426. The emulation module 408 may also modify the menu ifthe mapping module 402 has records indicating that the application 86 would modify the menu.

When the operating system 15 generates a message, the control module 220 of the client module 80 may forward the message to the application 86. The monitoring module 410 may monitor whether the application responds differently than anticipated by the emulation module 424. For example, the application may modify the menu attribute data 430 or change some other aspect of the menu's appearance or behavior. Accordingly the updating module 414 would invoke the caching module client 400 to update the menu attribute cache 426 and invoke the mapping module 402 to change any mappings 404, 406 as necessary. The emulation module 408 may then emulate the application's 86 behavior based on the updated menu attribute data cache 426 and mappings 404, 406. This may involve displaying the newly modified menu on the display 42. The emulation module 408 may also have to suppress user interface events generated in the delay between the time the menu was initially emulated and the time when it is re-emulated.

The predictive emulation module 116 and predictive emulation client 204 may also emulate an application's 86 behavior with respect to fonts. The caching module may transfer font attribute data 428 to the caching module client 400 to be stored in a font attribute data cache 430. The monitoring module 410 may detect all attempts by an application 86 to modify the font attribute data 428. The emulation module may use the font attribute data cache to display text having the expected font.

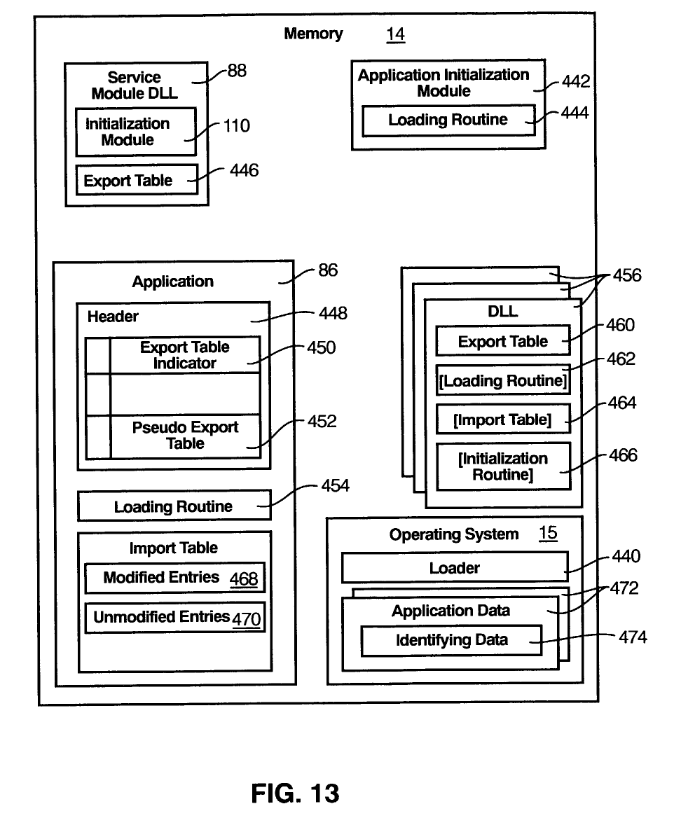

Referring to FIGS. 7 and 13, in order for the handler module 112 to intercept API calls 292, the import table 290 may need to be modified such that certain API calls 292 are linked to executable data within the handler module 112. An application 86 may be written such that entries in its import table will link to the handler module 112 using standard programming interfaces. For example, the application 86 may load the service module as a Dynamic Link Library (DLL). In order for applications that are not designed to function in accordance with the invention, the import table 290 may need to be modified.

Referring to FIG. 13, an application initialization module 442 may be associated with an application 86. The application initialization module 442 may have a loading routine 444 that invokes the loader 440 of an operating system 15 to load the service module DLL 88. Typically, a DLL will have an export table indicating the locations of functions available to an application 86. A DLL may also have an initialization routine 466 that is executed during the loading and linking process. Accordingly the service module 88 may be configured as a DLL having an export table 446 and an initialization module 110 serving as an initialization routine.

The loading routine 444 may then invoke the loader to load the application 86 into memory 14 as if it were a DLL. Because the application 86 may not be a DLL it may not have the format expected by the loader 440. To accommodate this the loading routine 444 may modify the application so that the loader recognizes it as a DLL. This may include modifying the header 448 of the application. The loader 440 may look in a certain place in a file's header 448 to detect the presence and location of the export table for that file.

Accordingly, the loading routine may modify the value stored at this export table indicator 450 to indicate the presence of an export table. The loading routine 444 may search the header 448 and find a pseudo export table 452 that the loader would recognize as an empty export table. The loading routine 444 may modify the export table indicator 450 to point to the location of the pseudo export table 452. The loader 440 will then recognize the application as a DLL and load it into memory 14.

The application 86 may have a loading routine 454 invoking the loader 440 to load the DLL's 456. The DLL's 456 typically have an export table 460. A DLL may also have a loading routine 462 invoking the loader 440 to link other DLL's 456 to its import table 464.

After loading all DLL's 456 into memory 14, the loader 440 will execute the initialization routines 110, 466 of all the DLL's in the order that they were loaded. The initialization module 110 will therefore be the first to execute. The initialization may modify the import table 290 of the application 86 such that certain modified entries 468 will be linked to the handler module 112, rather than to a DLL 456. The initialization module 110 may leave some unmodified entries 470, allowing some API calls 292 and calls to functions, which are not part of the operating system API, to execute normally.

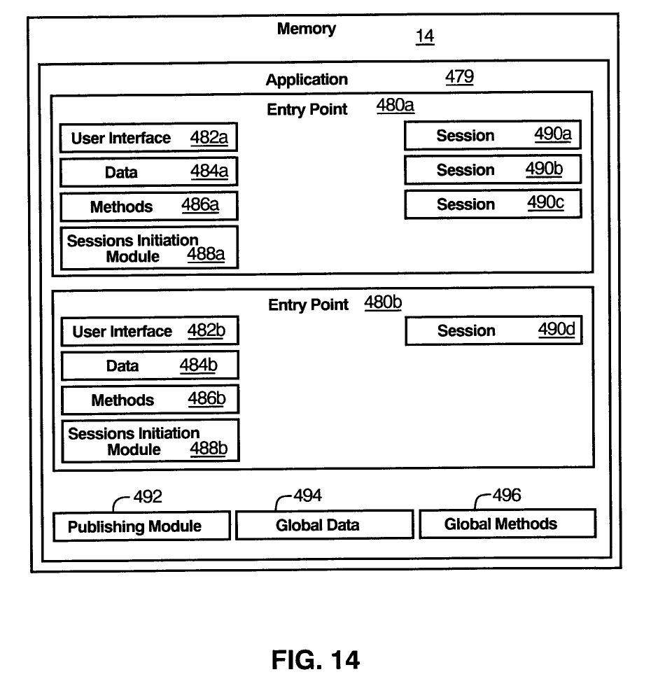

Referring to FIG. 14, a service module 88 may provide remote access to a multiple entry point application 479. A multiple entry point application 479 may allow more than one user to simultaneously access and control an application 479. Such an application 479 provides many advantages such as enabling a single executable to support multiple users interfaces (e.g. HTML, pocket PC, Windows™, and the like). An application 479 may also allow multiple user to collaborate.

For example multiple users may remotely edit a document without having to concern themselves that a user may be editing an older version of the document that doesn't include important revisions. Such an application 479 may provide the functionality of a conventional single entry point application to multiple users, yet it would only have to be launched and initialized once. This would reduce time spent loading application 479 executables from a storage device 16.

A legacy application that has not been created to take advantage of multiple entry points 480a,b may be modified to take advantage of them. A legacy application or an application 479 providing multiple entry point can also be easily modified to support a different interface by adding an entry point 480a,b that supports that interface.

An entry point 480a,b may have a user interface 482a,b through which a user may control the application and view output. Each user interface 482a,b may be different and allow access to data 484a,b and methods 484a,b unique to a particular entry point 480a,b. For example entry point 480a may have a user interface 482a that allows a user to access data 484a and methods 486a. Data 484a and methods 486a may be available exclusively to users accessing the application through entry point 480a.

An entry point 480a,b may have a session initialization module 488a,b that allows users to connect to an application 479. The session initialization module 488a,b may perform authentication before allowing a user to access an application. The session initialization module 488a,b may also create a session 490a-d for each connection between a user and the entry point 480a,b. A session 490a-d being data structures and processes unique to a connection between a user and an application 480a. A session 490a-c may include threads that are started when a user connects to the application 479. An entry point 480a,b may permit a fixed number of sessions 490a-c or permit as many as the server 100 has resources to process. For example, entry point 480b may allow only one session 490d at a time.

An application 479 may also have global data 494 and global methods 496 which are accessible from more than one entry point 480a,b. An application 492 may also have a publishing module 492 which publishes information concerning an application's 479 entry points 480a,b so that users may connect thereto. The publishing module 492 may provide information concerning available entry points to entry point management module 148. The entry point module 148 may provide this information to the launcher module 176 enabling users to connect to the entry points 480a,b.

The entry point management module 176 of the service module 88 may manage invoke the functionality of an application 479. For example the entry point management module 176 may respond to requests form the launcher module 176 and cause the session initialization module 488a to create a session 490c.

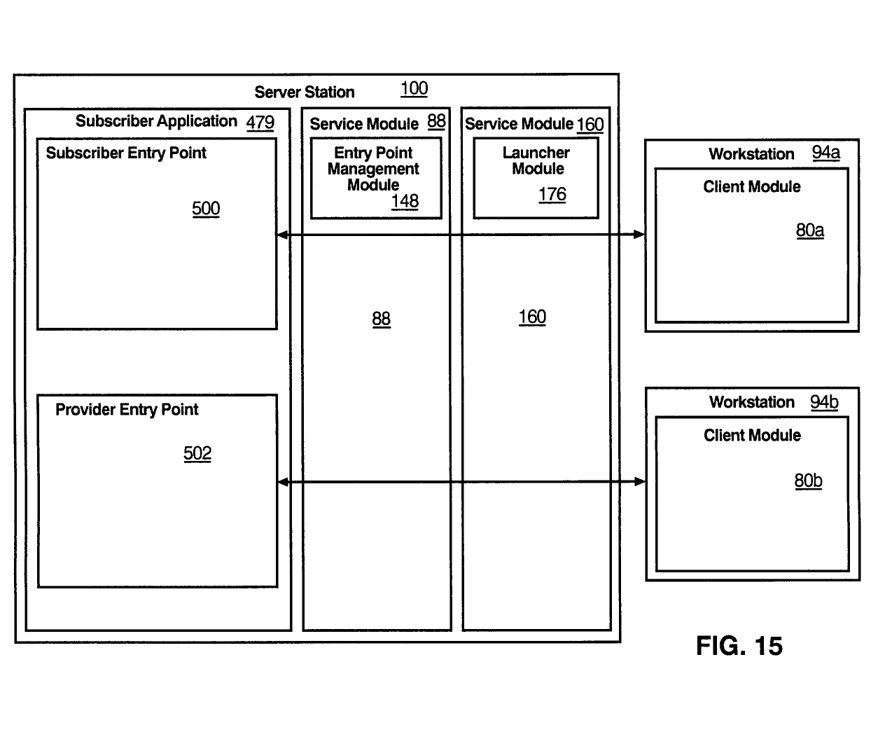

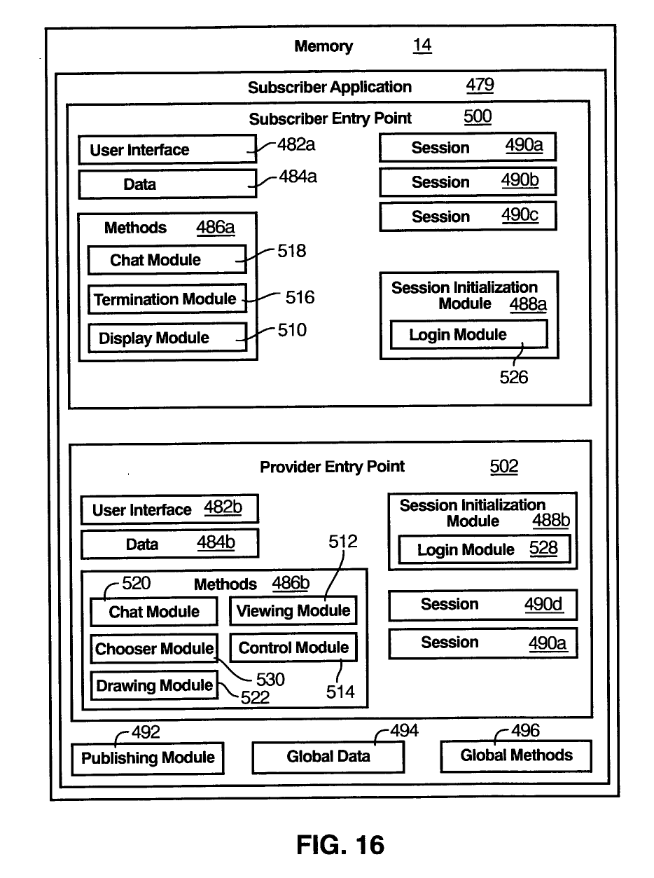

Referring to FIGS. 15 and 16, an application 479 having multiple entry points 480a,b may allow a user to obtain assistance or instruction from another user. A user at a workstation 94a may connect to a subscriber entry point 500 in order to obtain assistance from a provider of assistance at a workstation 94b connected to a provider entry point 502.

The methods 486a of a subscriber entry point 500 may include a display module 510 which may capture screen shots of a subscriber's workstation 94a. The provider entry point 502 may have a viewing module 512 that displays the captured display the screen shots on the provider's workstation 94b. In this manner the provider may see whatever the subscriber is seeing on his/her computer screen. The provider entry point 502 may also include a control module 514 which may allow a provider to control the workstation 94b of a subscriber in order to provide assistance. The subscriber entry point 500 may also have a termination module 516 which allows a user to prevent a provider from controlling the user's workstation 94a in the event that a subscriber is uncomfortable or suspicious of what the provider is doing.

The subscriber entry point 500 and provider entry point 502 may have chat modules 518 and 520, respectively. The chat modules 581 and 520 may enable a subscriber and a provider to send text messages to one another. The provider entry point may also have a drawing module 522. The drawing module 522 may enable a provider to draw on the screen of a workstation 94. A provider may employ the drawing module 522 in order to highlight important areas of the screen or to indicate where a user should click in order to accomplish some task.

The session initialization module 488a of the subscriber entry point 500 may include a login module 526. The login module 526 may require a user to enter a name and password before accessing the application 479. The session initialization module 488b may also have a login module 528 to authenticate users who attempt to connect to the subscriber application 479 as providers.

A provider entry point 502 may also have a chooser module 530. A chooser module 530 may present a list of subscribers who are currently connected to the application 479. The chooser may enable a provider to choose from the list of subscribers in order to see their screen, control their computer, and exchange text messages.

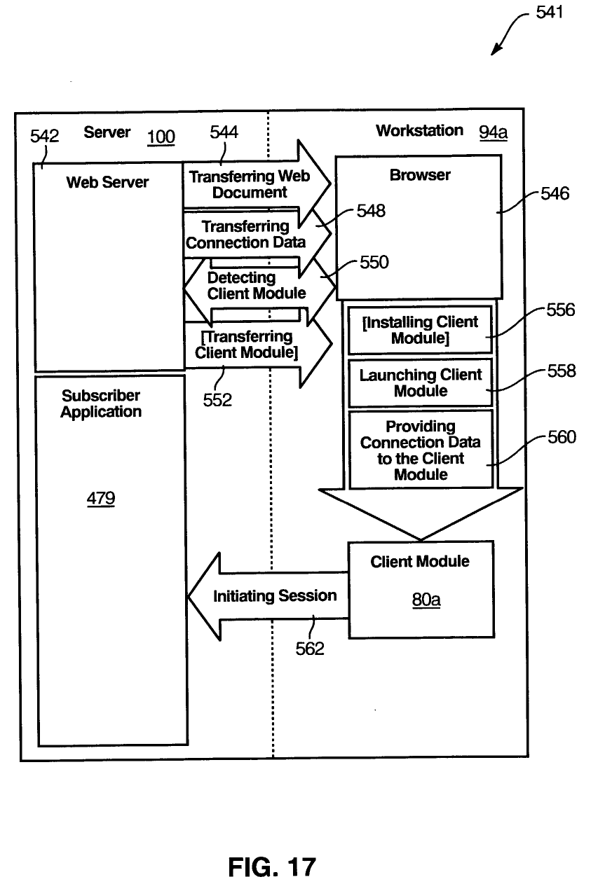

FIG. 17 illustrates a process 541 by which a user may connect to a subscriber application 479. A provider of assistance such as a technical support company or provider of a software package may have a web server 542. The web server may perform the step of transferring 544 a web document having a link to data needed for a user to connect to an application 479 or subscriber entry point 500 of an application 479. A user may click on the link, whereupon the web server may transfer 548 the connection data to a browser 546.

The web server 542 may also detect 550 whether or not the workstation 94a has a client module 80a installed., in which case the web server may transfer 552 a client module to the workstation 94a and the client module may be installed 556 on the workstation 94a. Installation 556 may involve the browser 546 launching an installation program transferred with the client module in step 552.

The client module 80a may then be launched 558. This may be accomplished by the installation program launching the client module 80a when installation 556 is complete. In cases where the client module 80a is already is installed the browser 546 may be responsible for launching 558 the client module 80a. The browser 546 or installation program may provide 560 the connection data to the client module when it is launched. The client module 80a may then initiate 562 a session with the subscriber application 479.

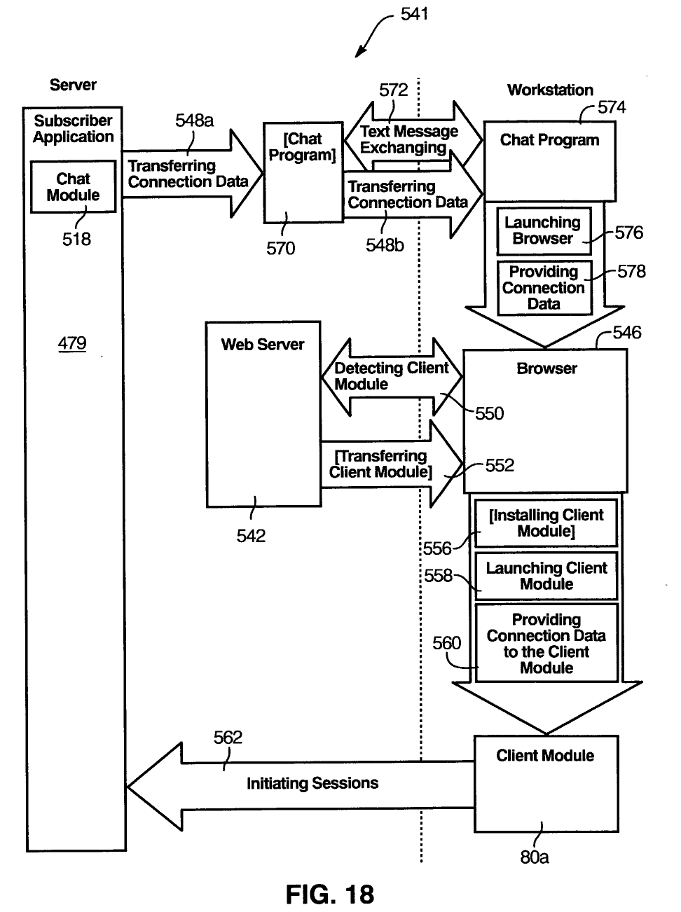

Referring to FIG. 18, a provider may use a chat program 570 to exchange 572 text messages with a subscriber running a chat program 574. In some embodiments the provider may make use of the chat module 518 residing in the subscriber application 479. The process 541 may involve connection data being transferred 548a to the chat program, either with or without direct involvement of a provider. The application 479 may provide the connection data and a provider may paste it into the chat program.

Alternatively the application 479 may transfer 548 the connection data to the chat program 570 without handling by a provider. The chat program 570 may then transfer 548b the connection data to the chat program 574. Typically the chat program 570 will transfer 548b the connection data as it would any other text message. In embodiments where the functionality of the chat program 570 is provided by the chat module 518, the connection data may be transferred 548a directly to the chat program 574.

Some chat programs are capable of recognizing web links, accordingly the subscriber application 479 may format the connection data as a web link. The chat program may recognize the connection data as a web link and launch 576 a browser 546, providing 578 the connection data to the browser 546. The web link may be linked to a web server 542 which may detect 550 whether a client module 80a is installed and if necessary transfer 552 a client module to the workstation 94.

The browser may also launch the installation 556 of the client module 80a if necessary. The browser or the installation program may launch 558 the client module, providing 560 connection data enabling the client module 80a to initiate 562 a session with a subscriber application 479. An advantage of the process of FIG. 18 is that a provider can more easily determine which, of all subscribers connected to an application 479 is the one with whom he/she is communicating.

In some situations the list presented by the chooser module 530 may be long and introduce some delay. The process of FIG. 17 allows a provider to supply connection data at the time of connection by the user, enabling the provider to more readily find which user to choose by noting that the user will have just connected. In situations where there is a number of people providing assistance the process of FIG. 17 enables a provider to provide connection data which may identify which application 479 the provider is connected to as well as the session 490d,e that belongs to that particular provider.

The subscriber application 479 may be employed in a variety of contexts. For example, the subscriber application 479 may be used in the technical support arena, in which case the subscriber would be a user seeking technical support from a provider of assistance, such as a technical support provider. In another example, a system administrator may be a provider, while the users of the system may be subscribers. In yet another example, a school teacher may be a provider, while the teacher's students act in the role of subscribers during the conduct of computerized instruction and learning or vice versa.

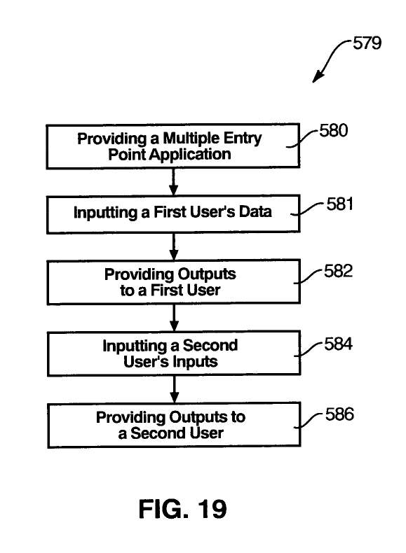

Referring to FIG. 19, a method 579 for using an application 479 having multiple entry points may include the step of providing an application 479 having multiple entry points, inputting 581 a first user's data to the application, and providing 582 outputs to a first user. Providing 582 outputs typically involves operating on the user inputs and may involve operating on other data available to the application. The method 579 may also include the steps of inputting 584 a second user's data and providing 586 outputs to a second user. Providing outputs 586 may likewise involve operating on the second user's inputs as well as operating on other data available to the application 579 such as the inputs of the first user. The steps 581, 582, 584, 586 may occur substantially simultaneously.

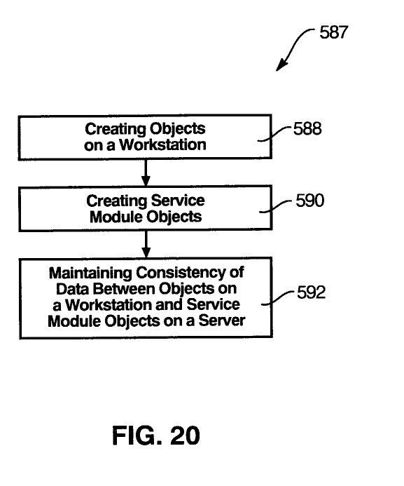

Referring to FIG. 20, a method for object management 587 may include the steps of creating 588 objects on a workstation 94, creating 590 corresponding service module objects, and maintaining 592 consistency of data between the objects and the service module objects.

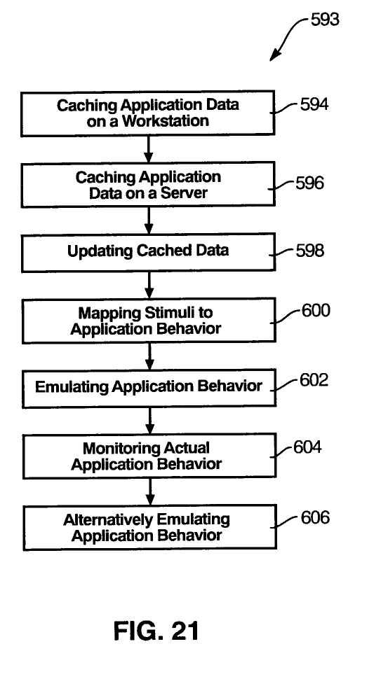

Referring to FIG. 21, a method 593 for performing predictive emulation may include the steps of caching 594 application data on a workstation 94, caching 596 application data 596 on a server, updating 598 cached data, mapping 600 stimuli to application behavior, monitoring 604 actual application behavior, and, optionally, alternatively emulating 606 application behavior.

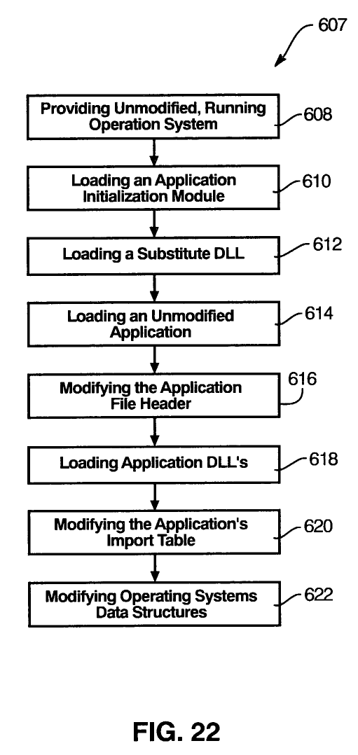

Referring to FIG. 22, a method for initializing an application 86,479 may include the step of providing an unmodified, running operating system 15. “Unmodified” meaning that the operating has not been modified beyond customization interfaces provided by the operating system 15 vendor. The operating system 15 need only be unmodified in areas relating to its ability to serve as a platform for application serving, not in areas relating to performance.

The method 607 may also include the steps of loading 610 an application initialization module, loading 612 a substitute DLL, loading 614 an unmodified application, modifying 616 the application file header, loading 618 application DLL's, modifying 620 the application's import table, and modifying 622 operating system 15 data structures. An unmodified application is one that has not been modified beyond customization through interfaces provided by the vendor of the application. An unmodified application may be one that has been modified beyond customization through interfaces provided by the application vendor but where the modifications do not relate to the application's ability to provide application serving functionality.

Apparatus and methods in accordance with the invention provide a variety of benefits. The invention provides the ability to drag and drop for publishing an application. The invention may provide applications having multiple entry points, each for a different workstation 90, 94, user computer 78, PDA 96 user, group, or other entity in order to provide only so much of the application functionality as needed, along with the proper formatting and the like.

When the computer is run as a file server, then the application server (which can launch applications) has services within it that act like operating system functionalities. The invention seamlessly serves any software application to a workstation without modification or customization of the software application.

The invention is scalable to be run on an n-way server with no inherent limit (e.g., HP is going to 64-way). The invention provides the capability of local Printing without having to configure the printer as a network printer. Embodiments of the present invention may permit a user to print or draw to any resource without regard to where the resources is located. That is, a local resource may be made available through the local workstation 94.

Embodiments of the present invention may assist in preventing race and starvation. If a message is being sent faster than the other side is acknowledging, then the present system may slow down and await a rate of acknowledgment. Embodiments in accordance with the present invention may work in terms of number of units rather than the number of bytes. This also means everyone gets services, since everyone is transmitting units. A server may accomplish this by maintaining a running total of the number of outstanding messages not yet acknowledged.

Embodiments in accordance with the present invention may communicate through HTTP handshaking. This may help get past fire walls, and work with fire walls and server farms. A server may provide full menu emulation, which may be the only way to get responsiveness. The server may be accessed by a one click connection. Such an icon may be on the desktop of a user's workstation 78, 90, 94. Embodiments of the present invention may provide intelligent message sending. Typically windows sends messages for winproc updating status and coordinating activity. When this happens, information goes into windows and results in requests wasting the time of the server. A server in accordance with the present invention may cause the workstation 94 to short out the message and tell the workstation 94 operating to handle it. In some instances, the client module may also report the same to the server.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for serving applications, the apparatus comprising:
a processor, for executing executable data structures;
a memory device operably connected to the processor for storing the executable data structures and associated operational data structures, the executable and operational data structures comprising:
a service module configured to manage application procedure calls of an application to select functions for processing on a remote workstation;
a client module configured to submit the selected functions to the workstation for processing.

2. A method for initializing an application to receiving inputs from a remote computing device and providing outputs to a remote computer device, the method comprising the steps of:
providing an executing operating system;
loading an application initialization module;
loading a substitute dynamic link library;
providing an application;
loading an application;
modifying the file header of the application;
loading at least one application dynamic link library;
modifying the import table of the application;
modifying the data structures of the executing operating system;

3. The method of claim 2, wherein the executing operating system and application are substantially unmodified

4. An apparatus for executing applications, receiving inputs from a remote computing device and providing outputs to a remote computing device, the apparatus comprising:
a first computing device having a processor for executing executable data structures and operably connected to a first memory, the first memory storing an application, a service module executable by the processor, and an operating system, the application sending original procedure calls to the operating system for execution;
a second computing device having a second processor and a second memory operably connected to the second processor, the second memory storing a client module executable by the second processor and an operating system; and
a network providing a communication channel between the first computing device and the second computing device;
the service module managing the original procedure calls, the service module further comprising a redirection module, the service module selectively causing the redirection module to send a notification through the network to the client module, the client module responding to the notification invoking the second operating system to process a corresponding procedure call.

5. The apparatus of claim 4, wherein the service module further comprises an object management module and the client module further comprises a client object management module; the object management module creating server objects and storing the server objects in the first memory; the object management module notifying the client object management module of the creation of the server objects, the client object management module creating a corresponding client object and storing the client object in the second memory.

6. The apparatus of claim 5, wherein the service module further comprises a predictive emulation module and the client module further comprises a predictive emulation client, the service module monitoring the processing of the application to compile behavior data, the service module communicating the behavior data to the predictive emulation client over the network, the predictive emulation client mimicking the application processing using the behavior data.
